(19) United States
(12) Patent Application Publication
(10) Pub. No.: US 2026/0097958 A1
(43) Pub. Date: Apr. 9, 2026

(54) BENCHTOP METHOD FOR MAKING THERMOELECTRIC SILVER SELENIDE-BASED MATERIALS

(71) Applicant: Iowa State University Research Foundation, Inc., Ames, IA (US)

(72) Inventors: Kirill Kovnir, Ames, IA (US); Yao Abusa, Ames, IA (US)

(73) Assignee: Iowa State University Research Foundation, Inc., Ames, IA (US)

(21) Appl. No.: 19/339,536

(22) Filed: Sep. 25, 2025

Related U.S. Application Data
(60) Provisional application No. 63/703,459, filed on Oct. 4, 2024.

(51) Int. Cl. C01B 19/00

(52) U.S. Cl. CPC C01B 19/007; C01P 2002/54; C01P 2002/72; C01P 2002/82; C01P 2002/85; C01P 2002/88; C01P 2004/03; C01P 2004/04; C01P 2006/40

(57) ABSTRACT

Disclosed are embodiments of a near-room temperature thermoelectric material β-Ag₂Se. Interstitial, vacancy, and substitutional doping has been used to tune the charge and heat transport properties of the parent β-Ag₂Se structure to enhance thermoelectric performance. The transformation of β-Ag₂Se into α-Ag₂Se at ˜134° C. and the low solubility of dopants are obstacles to this doping approach. Embodiments of the present disclosure relate to a facile, safe, scalable, and cost-effective benchtop approach to successfully produce doped β-Ag₂Se. The doped materials provide enhancement of thermoelectric performance with a high peak zT of 1.30 at 117° C. and an average zT of about 1.15 in the 25-120° C. range for 0.2 at. % Zn-doped Ag₂Se. Zn doping into Ag vacancies/interstitials creates point defects, enhancing the scattering of phonons and tuning the charge carrier properties—leading to the significant suppression of thermal conductivity.

### CROSS-REFERENCE TO RELATED PATENT APPLICATIONS

This patent application claims the benefit of U.S. Provisional Patent Application No. 63/703,459, filed Oct. 4, 2024, the entire teachings and disclosure of which are incorporated herein by reference thereto.

### STATEMENT REGARDING FEDERALLY SPONSORED RESEARCH AND DEVELOPMENT

This invention was made with government support under DMR2003783 and DMR2333388 both awarded by the National Science Foundation. The government has certain rights in the invention.

### FIELD OF THE INVENTION

This invention generally relates to thermoelectric materials and, in particular, to an Ag₂Se-based thermoelectric material and method of producing same.

### BACKGROUND OF THE INVENTION

Over-dependence on fossil fuels and the high depletion of our ecosystem has prompted intensive research in renewable energy and efficient energy utilization. As a potential strategy to optimize energy efficiency and achieve carbon neutrality, thermoelectric (TE) technology has drawn considerable attention. Thermoelectric technology employs materials that can directly convert heat into electrical power and vice versa. They are capable of harvesting low-grade heat from the environment to be utilized for numerous applications. The TE energy conversion efficiency depends on a dimensionless figure of merit, zT=S²σT/Kₜₒₜ, where S, a, T, Kₜₒₜ represent the Seebeck coefficient, electrical conductivity, absolute temperature in Kelvin, and the total thermal conductivity (which is comprised of two parts: electronic (Kₑ) and lattice (Kₗ) thermal conductivity), respectively. Thus, for a high-performance TE material, an increase in power factor (S²σ) and a decrease in thermal conductivity are essential.

However, these parameters are strongly and adversely related, making it difficult to optimize zT. Attempts such as band structure engineering through doping and alloying have been implemented to tune the carrier concentration (n) and Hall mobility (μ) of TE materials—a strategy which has been successful in modifying the electronic structure of materials and in turn optimizing the TE power factor. Likewise, structural engineering through the creation of atomic-level defects, nanoscale grain boundary engineering, and hierarchical architectures aimed at enhancing phonon scattering have also been adopted to decrease thermal conductivity. As a result of these modifications, there has been tremendous success in developing advanced inorganic TE materials with high performance, particularly for those operating at medium and high temperatures. Unfortunately, TE materials operating at near room temperatures have seen less rapid progress.

The emergent chalcogenide thermoelectric material, n-type β-Ag₂Se, has the potential to replace currently utilized Bi₂Te₃-based thermoelectric for near room temperature applications. The need for this replacement stems from the low performance of n-type Bi₂Te₃-based materials and the low abundance of tellurium (0.001 ppm in the earth's crust), limiting their potential cost effectiveness and application. As such, Ag₂Se-based materials are gaining increasing attention as near room temperature TEs owing to their environmental friendliness, chemical stability, abundant constituent elements, and high ductility. β-Ag₂Se is a narrow bandgap semiconductor (˜0.07 eV) with an intrinsic n-type behavior owing to donor effect of Ag interstitials. β-Ag₂Se is stable up to 134° C., and above this temperature, it transforms to high temperature modification α-Ag₂Se, which is a superionic conductor with high level of disorder in Ag sublattice. Benefiting from its narrow bandgap and complex crystal structure, β-Ag₂Se exhibits high electrical conductivity, moderate Seebeck coefficient, high Hall mobility, and intrinsically low lattice thermal conductivity resulting in an overall high thermoelectric figure of merit (zT).

Despite these interesting properties, the material's sensitivity to stoichiometry and synthesis makes it challenging to tune its thermoelectric performance. As such, there have been a decent number of synthetic approaches developed to boost the thermoelectric performance of this material. zT values ranging from 0.3 to 0.99 at room temperature have been reported for bulk samples; however, maintaining a consistent zT within the working temperature has been challenging. The inconsistency in zT values both at room temperature and across measured temperatures have been attributed to the poor reproducibility of developed synthetic methods and the coexistence of metastable phases with the orthorhombic structure, which mainly arise due to the migration of Ag ions at various temperatures.

A method involving high-temperature solid-state reactions has been successfully demonstrated in the synthesis of β-Ag₂Se. The drawbacks of this method include: (i) exposure of sample to undesired high-temperature a-phase which negatively impacts the material's thermoelectric performance; and (ii) doping/substitution of Ag₂Se with other metals is challenging because the dopant solubility at high and room temperature may be quite different. Moreover, substituted/doped phases often have metastable nature and decompose when heated to high temperatures. At lower temperatures, the sluggish kinetics of solid-solid diffusion prevents decomposition of such doped/substituted phases in a practically reasonable timeframe.

As such, solution-based methods have recently been adopted as an alternative for synthesizing single-phase β-Ag₂Se-based materials with decent thermoelectric performances. However, the drawbacks of these methods include toxicity of starting materials, bulky nature of solvents/surfactants employed (which adversely impact the electronic transport of charge carriers), inconsistency in product yield and quality, and difficulty in controlling reaction rate.

Other methods such as high-energy mechanical milling and pulsed hybrid reactive magnetron sputtering techniques are also in active use to produce β-Ag₂Se materials. Unfortunately, these techniques are energy-intensive and time-consuming. Se and Ag powder have been reported to react at room temperature to form phase-pure β-Ag₂Se by hand-mixing, but the prolonged reaction time and the limited potential for doping may prevent usability of this method in boosting the thermoelectric performance of β-Ag₂Se.

In view of the drawbacks identified by Applicant, the present disclosure provides an alternative process to make β-Ag₂Se-based materials efficiently and in high yield. Additionally, embodiments of the present disclosure involve the use of lower cost starting reagents to make the β-Ag₂Se-based materials. Still further, embodiments of the present disclosure provide for a process to make these materials using a sustainable and safer reagents.

### BRIEF SUMMARY OF THE INVENTION

According to aspects of the present disclosure, embodiments of a method to produce β-Ag₂Se-based materials are disclosed that overcome the synthetic challenges and barriers outlined above. According to embodiments, the method described herein has been utilized to make a high yield of β-Ag₂Se samples (>95% yield) in less than an hour (in particular, within minutes). Advantageously, the disclosed method, which has been used to produce batches of synthesis of ˜5 g, can easily be scaled to industrial-size production.

In one or more embodiments, the method is further extended to make a series of doped β-Ag₂Se samples with a thermoelectric figure-of-merit (zT) reaching as high as 1.30 at 120° C. and average zT of 1.15 in a range of temperatures from 25° C. to 120° C. range, thus outperforming all reported β-Ag₂Se-based materials to Applicant's knowledge and is on par with the best Bi₂Te₃-based materials.

Various embodiments of the present disclosure relate to the following specific aspects. These aspects are presented by way of illustration and not limitation.

Aspect 1 relates to a method of preparing a thermoelectric compound. In the method, a solution comprising Se is heated to a temperature below 130° C. A first compound comprising Ag is added to the solution to form a mixture, and the mixture is reacted to produce a β-Ag₂Se compound.

Aspect 2 relates to the method of Aspect 1 in which the solution comprises a monoamine, a polyamine, or an alkanol amine.

Aspect 3 relates to the method of Aspect 1 or Aspect 2 in which the solution comprises ethylenediamine, diaminopropane, diethylenetriamine, alkylamine, ethanolamine, or propanolamine.

Aspect 4 relates to the method of any of Aspects 1-3 in which the first compound is a salt of Ag.

Aspect 5 relates to the method of Aspect 4 in which the salt of Ag is a halide, AgNO₃ and Ag₂CO₃.

Aspect 6 relates to the method of any of Aspects 1-5 in which the adding further comprises adding a second compound comprising an element other than Ag.

Aspect 7 relates to the method of Aspect 6 in which the element is Zn, Mg, Al, P, Si, Mn, Ni, Pb, Cd, Sn, Bi, S, or Te.

Aspect 8 relates to the method of Aspect 6 or Aspect 7 in which the β-Ag₂Se compound comprises up to 1.0 at % of the element.

Aspect 9 relates to the method of any of Aspects 1-8 in which the β-Ag₂Se-based compound comprises a figure of merit zT of at least 0.7 at 120° C.

Aspect 10 relates to the method of any of Aspects 1-9 in which the β-Ag₂Se-doped compound comprises an average figure of merit zT of at least 0.98 across a whole temperature range of 25° C. to 120° C.

Aspect 11 relates to a method of preparing a thermoelectric compound. In the method, one or more solid reactants comprising Se and Ag are added to a solvent to form a mixture. The solvent is heated to a temperature below 130° C. The mixture is reacted to produce a β-Ag₂Se compound.

Aspect 12 relates to the method of Aspect 11 in which the solvent comprises a monoamine, a polyamine, or an alkanol amine.

Aspect 13 relates to the method of Aspect 11 or Aspect 12 in which the solution comprises ethylenediamine, diaminopropane, diethylenetriamine, alkyl amine, ethanolamine, or propanol amine.

Aspect 14 relates to the method of any of Aspects 11-13 in which a first solid reactant of the one or more solid reactants is a salt of Ag.

Aspect 15 relates to the method of Aspect 14 in which the salt of Ag is a halide, AgNO₃ and Ag₂CO₃.

Aspect 16 relates to the method of any of Aspects 11-15 in which a second solid reactant of the one or more solid reactants is elemental selenium, ethanolamine, salt of Ag (AgCl, AgBr, AgI, AgNO₃ or Ag₂CO₃) and dopants (Zn, Mg, Al, P, Si, Mn, Ni, Pb, Cd, Sn, Bi, S, or Te.).

Aspect 17 relates to the method of any of Aspects 11-16 in which the one or more solid reactants further comprises a third solid reactant comprising an element other than Ag.

Aspect 18 relates to the method of Aspect 17 in which the element is Zn, Mg, Al, P, Si, Mn, Ni, Pb, Cd, Sn, Bi, S, or Te.

Aspect 19 relates to the method of Aspect 17 or Aspect 18, wherein the β-Ag₂Se compound comprises up to 1.0 at % of the element.

Aspect 20 relates to the method of any of Aspects 11-19 in which the β-Ag₂Se-based compound comprises a figure of merit zT of at least 0.7 at 120° C.

Aspect 21 relates to the method of any of Aspects 11-20, wherein the β-Ag₂Se compound comprises an average figure of merit zT of at least 0.98 across a whole temperature range of 25° C. to 120° C.

Aspect 22 relates to a thermoelectric compound comprising β-Ag₂Se and a dopant. The thermoelectric compound comprises a figure of merit zT of at least 0.7 at 120° C.

Aspect 23 relates to the thermoelectric compound of Aspect 22 in which the dopant is Zn, Mg, Al, P, Si, Mn, Ni, Pb, Cd, Sn, Bi, S, or Te.

Aspect 24 relates to the thermoelectric compound of Aspect 22 or Aspect 23 in which the β-Ag₂Se comprises up to 1.0 at % of the dopant.

Aspect 25 relates to the thermoelectric compound of any of Aspects 22-24 in which the thermoelectric compound comprises an average figure of merit zT of at least 0.98 across a whole temperature range of 25° C. to 120° C.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a flow diagram of a method of preparing a β-Ag₂Se thermoelectric material, according to an embodiment of the present disclosure;

FIG. 2 is flow diagram of another method of preparing β-Ag₂Se thermoelectric material, according to an embodiment of the present disclosure;

FIGS. 3A and 3B are powder X-ray diffraction patterns for six samples of β-Ag₂Se (FIG. 3A) and for four Zn-doped β-Ag₂Se samples (FIG. 3B), according to embodiments of the present disclosure;

FIGS. 4A and 4B provide a contour plot and selected temperature-dependent in situ PXRD patterns of an undoped Ag₂Se sample, respectively, according to embodiments of the present disclosure;

FIGS. 4C and 4D provide a contour plot and in situ PXRD patterns, respectively, for a Zn-doped Ag₂Se sample, according to embodiments of the present disclosure;

FIGS. 5A and 5B depict in situ PXRD patterns during heating and cooling, respectively, of a sample Ag₂An_{0.0039}Se, according to embodiments of the present disclosure;

FIG. 6 provides a differential scanning calorimetry (DSC) thermogram of a 0.25 at. % Zn-doped Ag₂Se (Ag₂Zn_{0.0050}Se) sample showing the transformation between cubic and orthorhombic phases, according to an embodiment of the present disclosure;

FIGS. 7A-7G provide Rietveld refinement of a room-temperature synchrotron PXRD patterns for Ag₂Se at various levels of Zn doping, according to embodiments of the present disclosure;

FIG. 8 depicts high-resolution room temperature synchrotron PXRD data for ZnSe, β-Ag₂Se, and Ag₂Zn_{0.0039}Se, according to embodiments of the present disclosure;

FIG. 9 shows the dependence of the unit cell volume (obtained from Rietveld refinement) on the % Zn-dopant concentration as determined from wavelength dispersive spectroscopy (WDS), according to embodiments of the present disclosure;

FIG. 10 provides plots of lattice parameters and unit cell volume of pristine, 0.2 at. %, and 0.25 at. % Zn-doped Ag₂Se samples, according to embodiments of the present disclosure;

FIG. 11 shows the dependence of unit cell volume (obtained from Rietveld refinements of room-temperature in-house PXRD) versus % Zn-dopant concentration as determined from WDS, according to embodiments of the present disclosure;

FIGS. 12 and 13 provide pair distribution function curves for both short range (2 Å r≤5 Å) (FIG. 12) and long range (5 Å≤r≤20 Å) (FIG. 13) fit by the orthorhombic β-Ag₂Se structural model without any amorphous impurities, according to embodiments of the present disclosure;

FIG. 14 is a graph depicting an increase in unit cell volume with Zn doping, according to embodiments of the present disclosure;

FIG. 15 depicts Raman spectra obtained from the Raman scattering experiments for β-Ag₂Se, Zn-doped β-Ag₂Se, ZnSe, and a mixture of β-Ag₂Se and ZnSe, according to embodiments of the present disclosure;

FIGS. 16A-G provides energy dispersive x-ray spectroscopy (EDS) spectra of selected sites from the 0.25% Zn-doped Ag₂Se sample normalized to 2 Ag atoms, according to embodiments of the present disclosure;

FIG. 17 provides backscattered SEM images of 0.25% Zn-doped Ag₂Se sample collected during and after a SEM/WDS measurement, according to embodiments of the present disclosure;

FIGS. 18A-18C depict backscattered SEM images and elemental mapping of 0.2 at. %, 0.25 at. %, and 0.3 at. % Zn-doped Ag₂Se samples, respectively, showing the distribution of Ag, Se, and Zn, according to embodiments of the present disclosure;

FIGS. 19A-C depict high angle annular dark field scanning transmission electron microscopy (HAADF-STEM) energy dispersive x-ray (EDX) mapping showing a homogeneous distribution of Zn atoms across elemental maps of 0.25 at. % Zn-doped Ag₂Se (Ag₂Zn_{0.0050}Se) taken at different levels of magnification, according to embodiments of the present disclosure;

FIG. 20 depicts high resolution [001](top) and [010](bottom) HAADF-STEM images of the 0.25 at. % Zn-doped Ag₂Se (Ag₂Zn_{0.0050}Se) sample, according to embodiments of the present disclosure;

FIG. 21 provides electron diffraction patterns of the [001], [100], [301], [211] and [310] zones of 0.25 at. % Zn-doped Ag₂Se (Ag₂Zn_{0.0050}Se) indexed in the P2₁2₁2₁ structural model, according to embodiments of the present disclosure;

FIG. 22 is a high resolution [301] HAADF-STEM image of 0.25 at. % Zn-doped Ag₂Se (Ag₂Zn_{0.0050}Se) sample, according to embodiments of the present disclosure;

FIGS. 23A and 23B provide graphs of the temperature dependence of the electrical conductivity (FIG. 23A) and Seebeck coefficient (FIG. 23B) for β-Ag₂Se and Ag₂ZnₓSe samples (x=0.0039, 0.0050, and 0.0057 corresponding to 0.2, 0.25 and 0.3 at. % Zn doping respectively), according to embodiments of the present disclosure;

FIG. 23C and FIG. 23D provide graphs of the temperature dependence of Hall mobility (FIG. 23C) and carrier concentration (FIG. 23D) of β-Ag₂Se and Ag₂Zn_{0.0050}Se, according to embodiments of the present disclosure;

FIGS. 24A-C depict the temperature dependence of total thermal conductivity (FIG. 24A), power factor (FIG. 24B), and figure of merit zT (FIG. 24C) for pristine β-Ag₂Se and doped Ag₂ZnₓSe samples (x=0.0039, 0.0050, and 0.0057 corresponding to 0.2, 0.25 and 0.3 at. % Zn doping, respectively), according to embodiments of the present disclosure;

FIG. 24D provides a comparison of the peak and average figure of merit zT of Zn-doped β-Ag₂Se samples (25-120° C.), according to embodiments of the present disclosure, against other state-of-the-art room-temperature thermoelectric materials;

FIG. 25 shows the temperature dependent Hall concentration of pristine Ag₂Se and 0.25 at. % Zn-doped Ag₂Se samples, according to embodiments of the present disclosure;

FIGS. 26A-B show the temperature dependent Hall mobility (FIG. 26A) and carrier concentration (FIG. 26B) of pristine Ag₂Se and 0.25 at. % Zn-doped Ag₂Se samples, according to embodiments of the present disclosure;

FIGS. 27A-D provide an estimation of the bandgap from Arrhenius plot of electrical resistivity (from 300-390 K) for pristine and Zn-doped samples, according to embodiments of the present disclosure;

FIG. 28 provides a graph of the temperature-dependent electrical resistivity of Ag₂Zn_{0.0050}Se indicating metallic behavior below 100 K and semiconducting behavior above 100 K, according to embodiments of the present disclosure;

FIG. 29 provides a graph of electrical conductivity as a function of temperature as measured using three different instruments, Quantum Design Physical Property Measurement System (PPMS), Netzsch SBA 458 Nemesis (SBA), and LINSEIS LSR-3 (LSR), for a sample of Ag₂Zn_{0.0050}Se, according to embodiments of the present disclosure;

FIGS. 30A and 30B provide the temperature dependence of electronic (FIG. 30A) and lattice thermal conductivities (FIG. 30B) for pristine β-Ag₂Se and Ag₂ZnₓSe samples (x=0.0039, 0.0050, and 0.0057), according to embodiments of the present disclosure;

FIGS. 31A-31D provide graphs of the temperature dependent electrical conductivity (FIG. 31A), Seebeck coefficient (FIG. 31B), thermal conductivity (FIG. 31C), and thermoelectric figure-of-merit (zT) (FIG. 31D) of 0.25 at % Zn-doped Ag₂Se sample densified into a pellet (via spark plasma sintering, SPS) at 100° C. (SPS-100, blue symbols) and 200° C. (SPS-200, pink symbols), according to embodiments of the present disclosure; and

FIGS. 32A-32C provide a comparison of zT values of the Zn-doped Ag₂Se samples produced according to embodiments of the present disclosure with n-type Bi₂Te₃-based materials (FIG. 32A) and Ag₂Se-based materials obtained from different synthesis methods.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Embodiments of the present disclosure provide a simple, safe, cost effective, and efficient method to synthesize β-Ag₂Se and β-Ag₂Se-doped materials for near room temperature thermoelectric applications. The method developed utilizes benchtop chemistry, starting from such materials as elemental selenium (Se), silver chloride (AgCl), and a halide (MX₂ or MX₃ in which M═Al, P, Bi, Zn, Mg, Mn, Ni, Pb, Cd, Sn, S, Te and in which X can be F, Cl, Br, or I) as reagents to produce single phase β-Ag₂Se and β-Ag₂MₓSe materials at near room temperature, in particular in a temperature range of 60° C. to 100° C., with low processing temperature (<120° C.) within minutes. Advantageously, the presently disclosed synthetic approach avoids the formation of high temperature α-Ag₂Se which exhibits poor thermoelectric performance.

Embodiments of the presently disclosed method also provide additional advantages, including (i) a controlled reaction rate, providing uniform doping of main group and transition metals, (ii) the final products obtained via the presently disclosed method are phase pure and stoichiometric materials, (iii) the method utilizes simple, environmentally-friendly, and inexpensive reagents to synthesize the β-Ag₂Se-based materials at high yields with excellent thermoelectric performance, and (iv) the procedure can be readily scaled to industrial-size production. These and other aspects and advantages will be described more fully in relation to the embodiments present below and shown in the drawings. The embodiments are presented by way of illustration, not limitation.

In β-Ag₂Se thermoelectrics, doping is used to tune the material's carrier concentration and mobility which effectively enhances thermoelectric performance. This approach has proven useful in controlling the mobility of Ag⁺ ions which tunes the material's electronic structure through bandgap engineering. For instance, an improvement in electrical and thermal conductivity has been observed by incorporating 1% Cu into the lattice of Ag₂Se. In particular, a record-high zT of 1.2 at 120° C. was obtained, which was the largest reported for n-type Ag₂Se synthesized via wet chemistry. Similarly, a solvothermal route has been employed to partially substitute Sn for Ag in Ag₂Se, achieving a zT of 0.9 at room temperature. However, attempts to dope Zn into interstitial Ag sites via ball milling followed by spark plasma sintering (SPS) resulted in the formation of ZnSe nano-precipitates within the Ag₂Se matrix, resulting in lower zT values. The low solubility of Zn and other heterovalent dopants, coupled with Ag₂Se sensitivity to synthesis, restricts successful aliovalent doping with metals such as Zn.

Applicant hypothesized that aliovalent placement of the Zn in the interstitial/vacancy sites in Ag₂Se would modulate carrier concentration by the elimination of Ag interstitials, as well as create defects to suppress the lattice thermal conductivity. Inspired by this hypothesis, Applicant developed a simple, safe, cost-effective, and scalable solution route to successfully dope Zn into Ag₂Se. As will be discussed more fully below, the resultant material displays (to Applicant's knowledge) a record-high maximum zT of 1.3 at 120° C. and an average zT of 1.15 in the temperature range of 25° C. to 120° C. for 0.2 at. % Zn—Ag₂Se. The peak and average zT values reported herein are, to Applicant's knowledge, the highest for this family of materials and comparable to state-of-the-art Bi₂Te₃-based and Mg-based alloys which require high-temperature treatment for synthesis.

The low-temperature nature and simplicity of the developed method makes it useful for controlled doping into the Ag₂Se matrix, allowing for tuning the electronic and phonon properties.

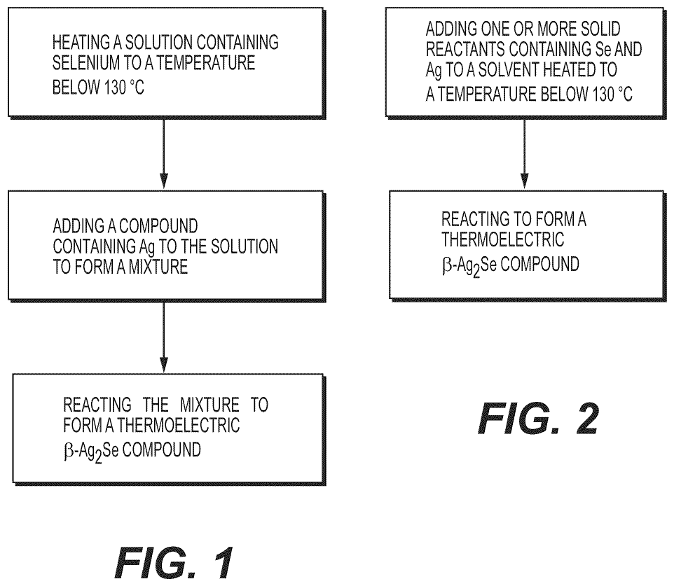

FIG. 1 provides a flow diagram of an embodiment of a method 100 of preparing the thermoelectric β-Ag₂Se-based material. In a first step 101 of the method 100, a solution containing elemental selenium (Se) is reacted, e.g., by stirring, rolling, sonication, vortexing, or otherwise agitating, at a temperature below 130° C., in particular in a range of 60 to 100° C., for a time in a range of 20 to 40 minutes. At a benchtop scale, the heating can take place on a hot plate, for example. At larger scales, heating may be performed using standard industrial reactors.

In one or more embodiments, the solvent for the Se-containing solution is a mono/polyamine or an alkanolamine. Examples of suitable mono/polyamines include ethylenediamine, diaminopropane, diethylenetriamine, and alkyl amine. Examples of suitable alkanol amines include ethanolamine and propanolamine. Preferably, the solvent has low chelating activity (alkanolamines are preferred over diamines) to minimize the formation of surface bound species, which negatively affects the electrical and thermal transport properties of the resultant material. Further, in one or more preferred embodiments, the solvent selected is not a strong reducing agent, specifically redox potential of the solvent is smaller than that for Ag⁺/Ag⁰ couple. Solvents with reducing properties promote the formation of Ago admixture in the subsequent step of the method 100. The formation of highly mobile Ago species increases carrier concentration by several fold and results in an overall poor thermoelectric performance of the resulting material. According to one or more embodiments, a particularly preferred solvent is monoethanolamine (ethanolamine), which Applicant has found to provide single-phase material synthesis with excellent properties.

In a second step 102 of the method 100, a solution containing an Ag salt is added to the solution heated in the first step 101. In one or more embodiments, the solution containing Ag salt is obtained by dissolving Ag salt in a solvent at near room temperature, e.g., about 60° C. for about 5 minutes. In one or more embodiments, the Ag salt is one or more of AgCl, AgBr, AgI, AgNO₃, and Ag₂CO₃. In one or more embodiments, the solvent for the solution containing Ag salts is the same solvent used for the Se-containing solution. Thus, in one or more embodiments, ethanolamine or propanolamine is particularly preferred. When adding the Ag during the second step 102, compounds containing dopants, such as Zn, Mg, Al, P, Si, Mn, Ni, Pb, Cd, Sn, Bi, S, or Te, may also be added. In one or more embodiments, the dopants are added to provide up to 1 at % of dopant to the β-Ag₂Se product. In a third step 103, the mixture is reacted such as by constantly agitating for a time in a range from 20 minutes to 40 minutes, such as for about 30 minutes. In one or more embodiments, the agitating takes place while the solution containing the Ag salt (and any other dopants) is added to the Se-containing solution, and in one or more other embodiments, the agitating continues after the solution containing Ag salt (and any other dopant) is added to the Se-containing solution. The resultant product obtained after reacting is a single-phase β-Ag₂Se. During the performance of the method 100, the reaction conditions are designed to ensure that the reaction is not exposed to temperatures beyond the β→α transformation of Ag₂Se (130° C.) to prevent the formation of high-temperature a-phase with poor thermoelectric performance.

As will be discussed more fully below, the product and phases present were confirmed using powder X-ray diffraction (PXRD) and scanning electron microscopy/energy dispersive spectroscopy (SEM/EDXS).

According to another embodiment of the present disclosure, a second method 200 as shown in FIG. 2 for producing β-Ag₂Se-based materials is provided. In a first step 201 of the method 200, one or more solid reactants containing Se and Ag are added to a solvent. Additionally, the one or more solid reactants may include a dopant as described above. In one or more embodiments, the solvent has been heated to a temperature below 130° C., in a range of 60° C. to 100° C. prior to adding the solid reactants. In one or more embodiments, the solvent may be heated to the temperature during or after adding the solid reactants. In one or more embodiments, the solvent is any of the mono/polyamines or alkanolamines listed above. In a second step 202, the solid reactants and solvent are reacted, e.g., by agitating, for a time in a range of 30 mins to 60 mins. In one or more embodiments, the solvent is being agitated while the solid reactants are being added, and in one or more other embodiments, the solid reactants are added, and then the solution is agitated.

After the step of reacting 202, highly crystalline Ag₂Se was produced with yields greater than 95%. Se(s) readily reacts with Ag⁺ at room temperature to form a mixture of Ag₂Se, Se(s) and Ag⁺ ions in solution. Applying heat (temperature gradient) to the resultant mixture promotes the complete reaction between Se(s) and Ag⁺ in solution to produce phase-pure Ag₂Se. Applicant has found that a temperature of 100° C. is enough to ensure this conversion, thus, enabling control over particle size and stoichiometry without exposing samples to temperatures above β→α transition.

As described, the presently disclosed methods provide sustainability and simplicity for controlled doping into the Ag₂Se matrix, allowing for tuning of the electronic and phonon properties of the Ag₂Se compound. In particular, embodiments of the presently disclosed methods can be extended to dope main group and transition metals (in small atomic concentration) into β-Ag₂Se to improve the thermoelectric performance of the resultant materials.

### EXPERIMENTAL EXAMPLES

In accordance with the above disclosure, Zn (<0.5 at.-%) was aliovalently doped into Ag₂Se which, as will be discussed more fully below, resulted in a surprisingly and unexpectedly large enhancement of thermoelectric performance.

Initial attempts to synthesize β-Ag₂Se utilized a reaction of an activated Se solution with solubilized AgCl at different temperatures (25-120° C.), and produced β-Ag₂Se samples with trace amounts of elemental Ag⁰ (sample SA1). The presence of Ag⁰ may be attributed to the reduction of Ag⁺ (in AgCl) under the reductive environment of Se solution. Addition of a sacrificial amount of Se powder (Se⁰) to the reaction mixture with continuous stirring eliminated the Ag⁰ observed, implying that Se in a lower oxidation state (0 or−1) is required to completely convert all Ag⁰ formed during reaction into silver selenide (sample SA2).

Reacting Se powder with AgCl in ethanolamine at room temperature (25° C.) yielded β-Ag₂Se and Se⁰(SA3). Treatment of the resultant mixture in ethanolamine at 100° C. for 30 minutes produced single-phase β-Ag₂Se (SA4).

Pre-treatment of the Se powder in ethanolamine at 100° C. for 20 minutes followed by the addition of stoichiometric amount of AgCl at room temperature produced a mixture of β-Ag₂Se and Se⁰ (sample SA5).

To produce single-phase multigram batches of β-Ag₂Se sample, 7 mmol of Se powder and 14 mmol of AgCl were treated in 10 mL ethanolamine at 100° C. for 30 minutes with continuous stirring (sample SA6).

Zn-doped β-Ag₂Se samples were synthesized in a similar fashion with the addition of x mmol ZnCl₂ (x=0.06, 0.08 and 0.12). A dark-gray precipitate was obtained, filtered, and washed with 200-proof ethanol. The final product appeared as crystalline dark-gray powders. The experimental yield of all single-phase β-Ag₂Se and Zn-doped β-Ag₂Se samples produced in the present work are greater than 95%.

A ZnSe standard for SEM//EDS/WDS and Raman spectroscopy was synthesized using traditional solid-state synthesis. Zn granules and Se powder were weighed in a 1:1 molar ratio and loaded in a silica ampoule. The ampoule was sealed under vacuum and then heated in a muffle furnace for 96 hours at 900° C. Phase formation was confirmed using PXRD.

In preparing the above samples, selenium powder (100 mesh, Sigma-Aldrich, 99.99%), silver chloride (Alfa Aesar, 99.997%), zinc chloride hexahydrate (Sigma-Aldrich, >98%), Zn granules (20 mesh, Alfa Aesar, 99.8%), and ethanolamine (2-aminoethan-1-ol, Thermo Scientific, 99+%) were used as received without further purification.

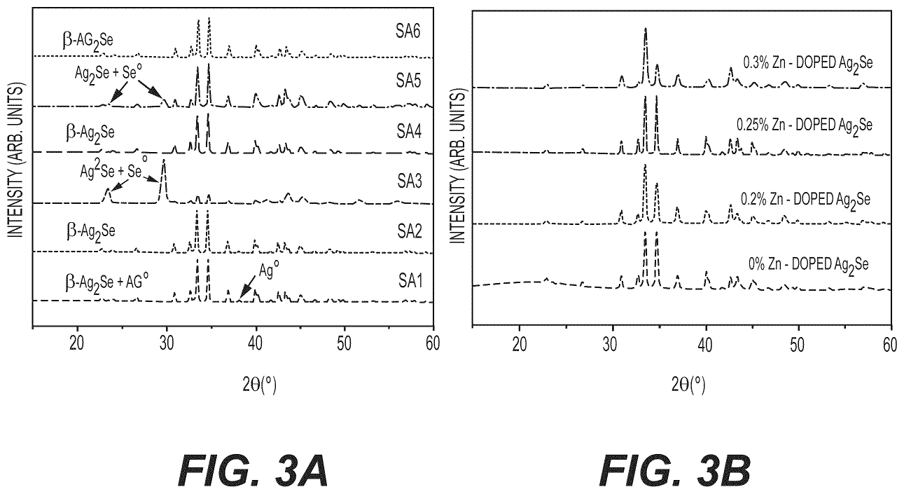

A summary of these synthetic results is given by the powder XRD patterns in FIGS. 3A (SA1-SA6) and 3B (Zn-doped samples). The powder X-ray diffraction (PXRD) patterns of all samples were indexed to orthorhombic β-Ag₂Se (P2₁2₁2₁) with no impurity phases within the detection limit of the method.

Synchrotron temperature-dependent in situ PXRD was employed to analyze changes in the crystal lattices and the possible formation of secondary phases induced by Zn doping. Variation in crystal structure with temperature was also studied for possible formation of metastable phases. In situ variable-temperature PXRD was performed at beamline 17-BM at the Advanced Photon Source at Argonne National Lab (APS ANL). Pre-synthesized doped and undoped β-Ag₂Se samples were finely ground then loaded into quartz capillaries with 0.5 mm ID (0.7 mm OD). The capillaries were evacuated and flame sealed. The sealed capillary was then placed into a secondary shield capillary (0.9 mm ID/1.1 mm OD) with a thermocouple as close as possible to the measurement area and mounted in a vertical manner to mimic a setup specific to solvothermal samples. Diffraction data were collected every minute at a rate of 10° C./min for 25-100° C. range, 2° C./min for 100-120° C. range, and 1° C./min to 120-140° C. range. For cooling, 2° C./min was used for 140-120° C. followed by slower cooling of 1° C./min for 120-70° C., and finally cooled to room temperature by turning heater off.

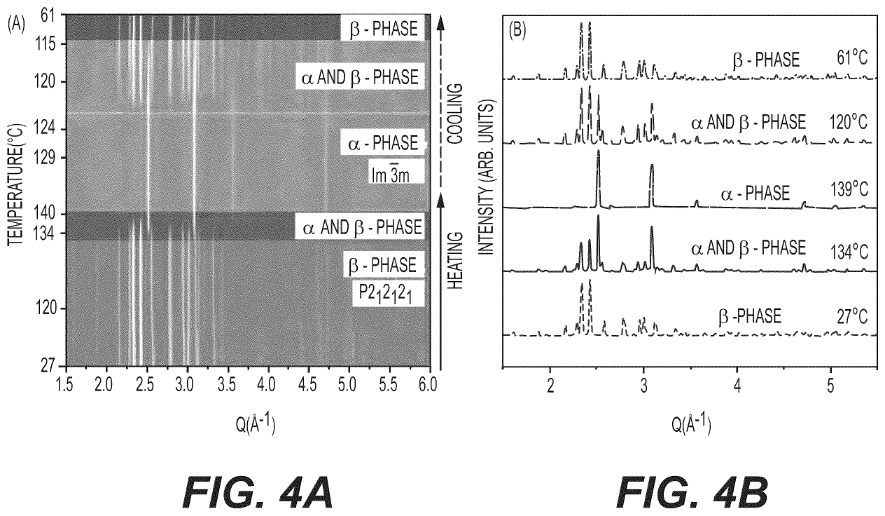

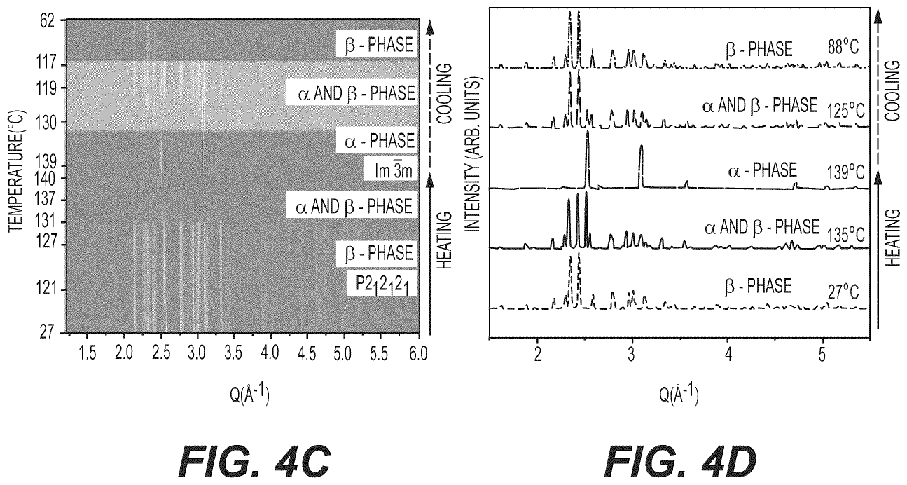

FIG. 4A provides a contour plot, and FIG. 4B provides selected temperature-dependent in situ PXRD patterns of an undoped Ag₂Se sample collected at the beamline 17-BM at the APS ANL upon heating and cooling. FIGS. 4C and 4D provide the same contour plot and in situ PXRD patterns, respectively, for a Zn-doped Ag₂Se sample.

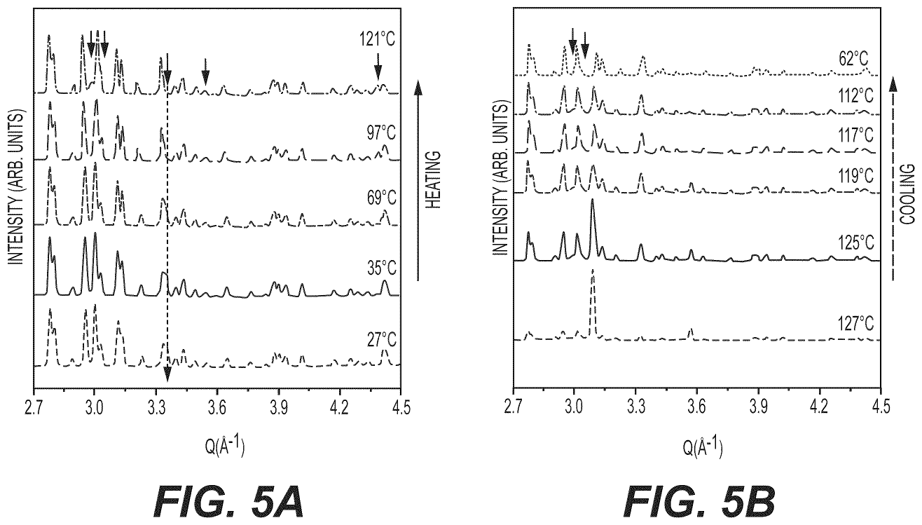

As can be seen from FIG. 5A, unidentified peaks were observed around 121° C. during the heating. Those peaks disappeared at the phase transition to high-temperature cubic a-phase, and as showed in FIG. 5B, the peaks reappeared during cooling until around 60° C. before the sample fully converted back into the orthorhombic β-phase. This observation was consistent for pristine and Zn-doped samples, and as such, the presence of these peaks cannot be ascribed to the effect of Zn doping. These peaks, however, could not be assigned to any previously reported metastable Ag—Se phases, ZnSe, or elemental Ag⁰ and Se⁰ phases.

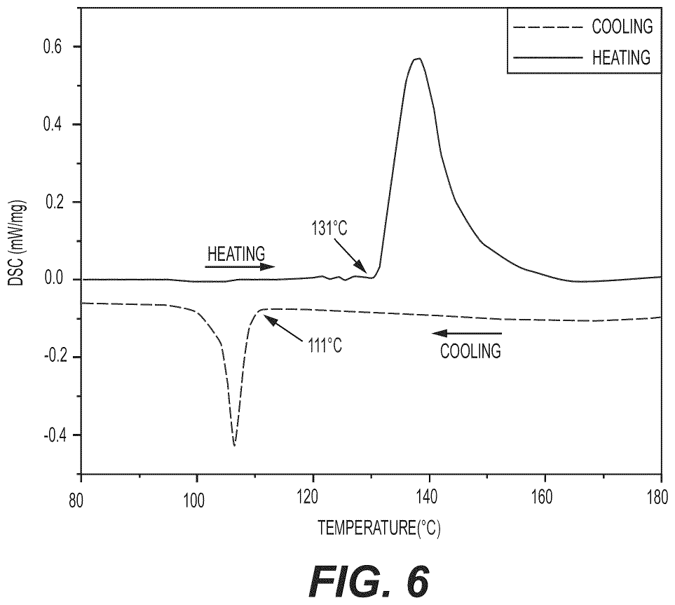

Variation of the lattice parameters is negligible in the undoped and Zn-doped β-Ag2Se samples at room temperature but varied slightly with increasing temperature due to thermal expansion. From the in situ diffraction experiment, Zn-doped samples undergo a β→α phase transition from the orthorhombic to the cubic phase around 131° C. while pristine Ag₂Se undergoes that transition at slightly higher temperature of 134° C. (see FIGS. 4A-4C). These results are consistent with other doped systems and agree well with the differential scanning calorimetry (DSC) data shown in FIG. 6, which provides DSC thermogram of the 0.25 at. % Zn-doped Ag₂Se (Ag₂Zn_{0.0050}Se) sample showing the transformation between cubic and orthorhombic phases. Specifically, the DSC heating curve of 0.25 at. % Zn-doped Ag₂Se sample exhibits a relatively broad exothermic peak consistent with the gradual β→α phase transition and a sharp endothermic peak upon cooling—indicative of a sharp αΘβ phase transition. The DSC experiments were performed with a NETZSCH DSC 400 F3 Pegasus. Powders of Zn-doped β-Ag₂Se were weighed (˜30 mg) and loaded into small, fused silica ampoules then evacuated and flame sealed. The samples were measured against a nearly identical, empty fused silica ampoule as a blank. All calorimetry measurements were performed with a heating rate of 10° C./min and cooling rate of 2° C./mins.

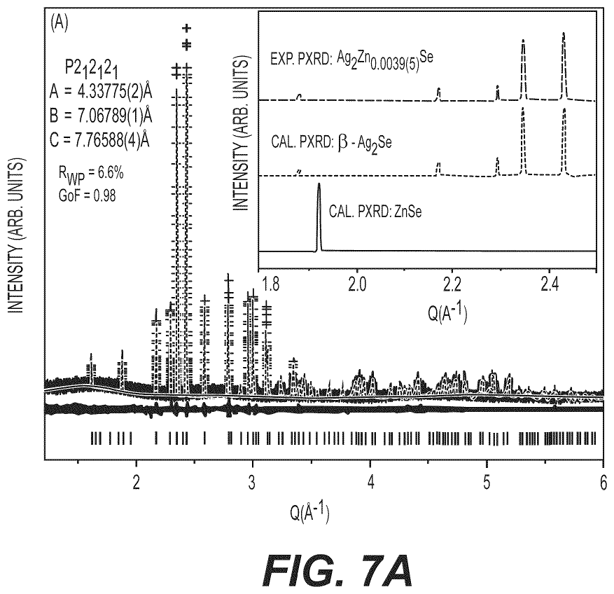

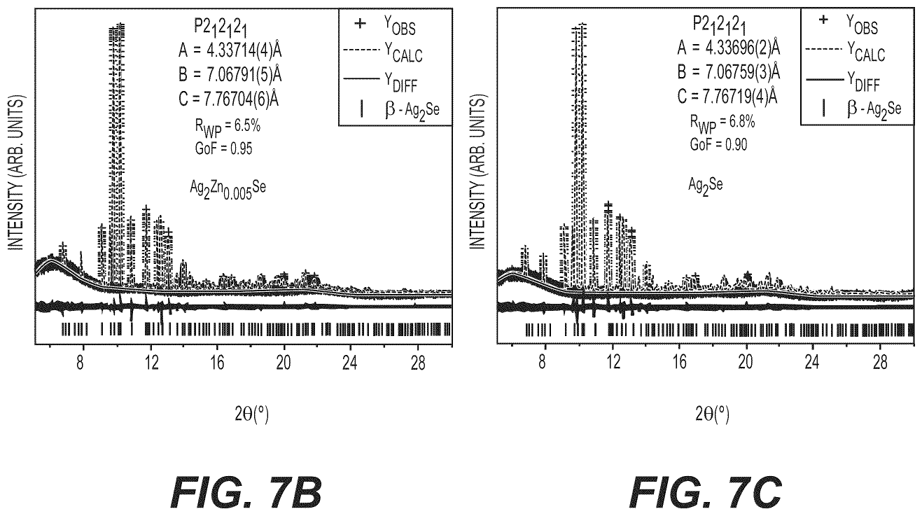

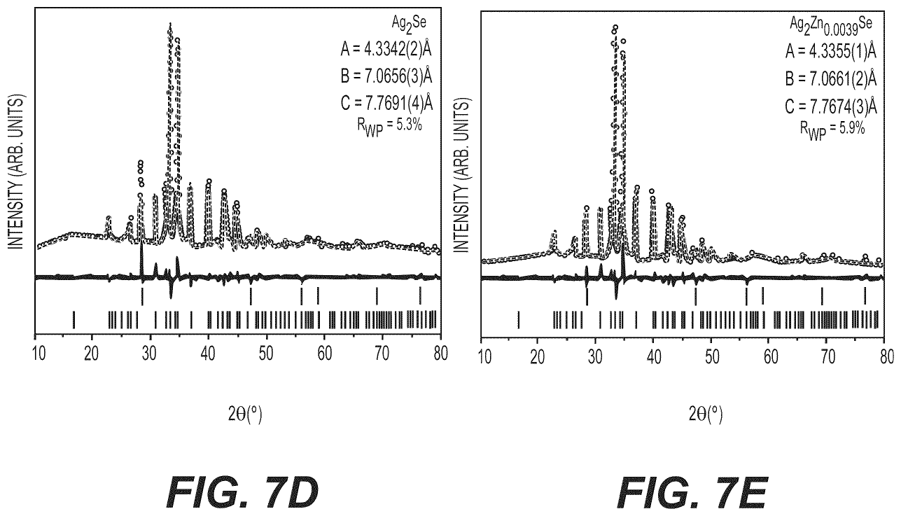

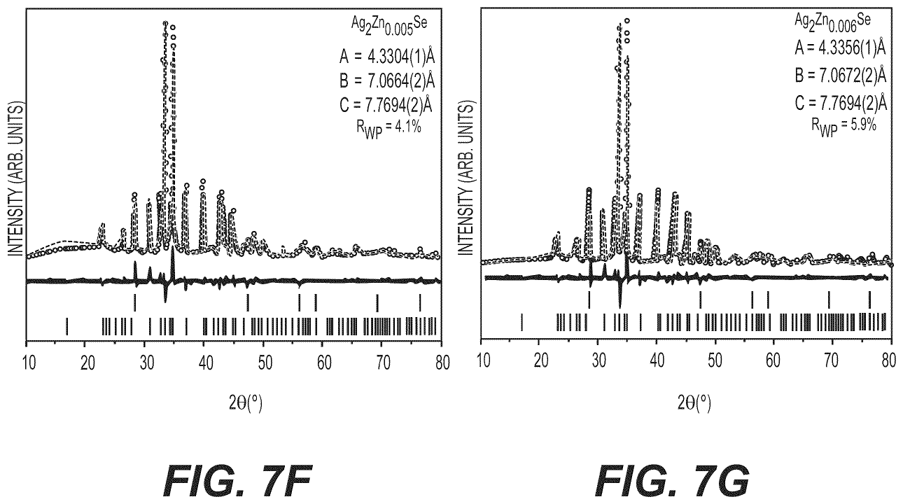

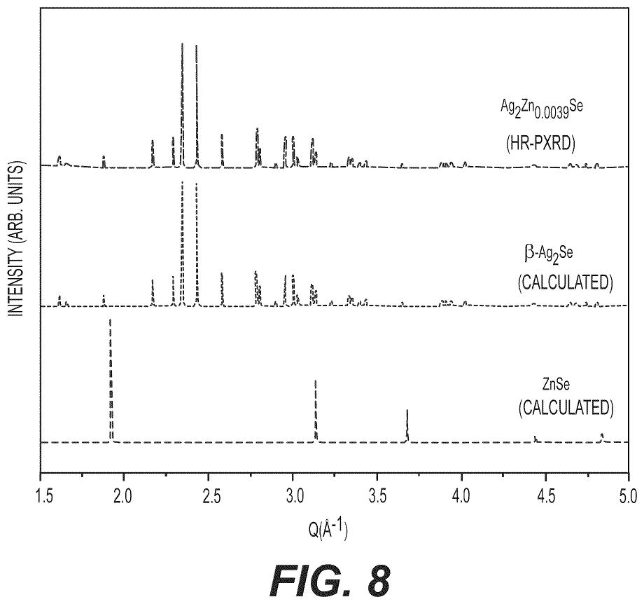

Rietveld refinement (FIGS. 7A-7G) of high-resolution room temperature synchrotron PXRD data (FIG. 8) confirmed the absence of admixture/secondary phases such as ZnSe, Zn, Se, or Ag attesting to the phase purity of the samples. General Structure Analysis System (GSAS-II) was used to perform the Rietveld refinement of synchrotron PXRD data using a structural model of β-Ag₂Se (JCPDS 24-1041). The refinement was carried out in the 2θ range of 3° to 300 for synchrotron data and in the 2θ range of 100 to 800 for laboratory diffraction data. The background and isotropic displacement parameters were refined for all samples. Unit cell parameters and atomic occupancies were also refined. Difference curves and R_{wp} residuals were used to evaluate the agreement between calculated and experimental diffraction patterns. Rietveld refinement was also carried out on the in-house PXRD datasets obtained from longer scan and 2θ range.

FIG. 7A provides Rietveld refinement of a room-temperature synchrotron PXRD pattern (λ=0.459723 Å) for 0.2 at. % Zn-doped Ag₂Se in which experimental data is shown as black crosses, calculated pattern is shown as a red line, difference profile is shown in blue, and vertical ticks indicate the positions for β-Ag₂Se peaks (space group: P2₁2₁2₁, No. 19). In FIG. 7A, the inset shows a zoomed in region of the experimental diffraction pattern of Zn-doped β-Ag₂Se along with calculated patterns for undoped Ag₂Se and ZnSe. FIGS. 7B and 7C depict Rietveld refinement of room-temperature synchrotron PXRD patterns for Ag₂Zn_{0.0050}Se and pristine β-Ag₂Se. In these figures, background is shown in green, and the broad background humps are from silica added to the samples to improve transmission. FIGS. 7D-7G depict Rietveld refinements of room-temperature in-house PXRD patterns for pristine and Zn-doped Ag₂Se samples. An internal standard (Si powder, SRM 640b, NIST, a=5.430940 Å) was utilized to obtain precise unit cell parameters (wine tick marks). In FIGS. 7D-7G, experimental data is shown as black circles. The calculated pattern remains a red line, and the difference profile also remains blue. FIG. 8 depicts high resolution powder XRD (HR-PXRD) of 0.2 at. % Zn-doped Ag₂Se compared to calculated powder XRD patterns of pristine Ag₂Se and ZnSe.

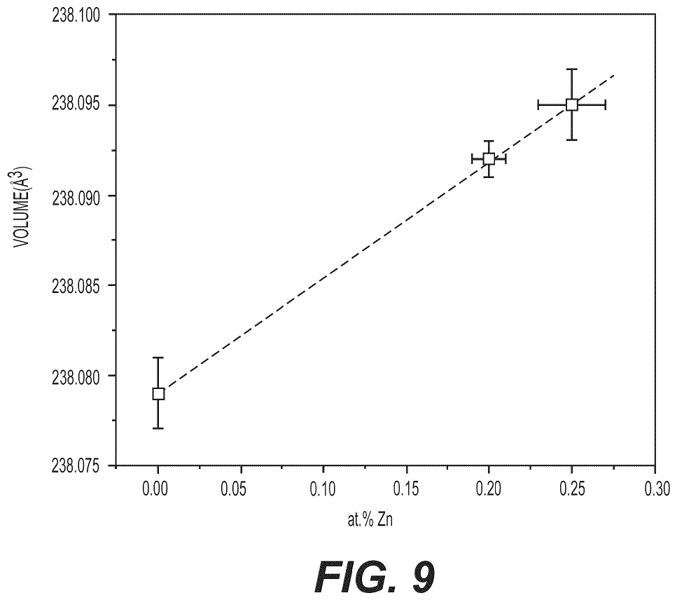

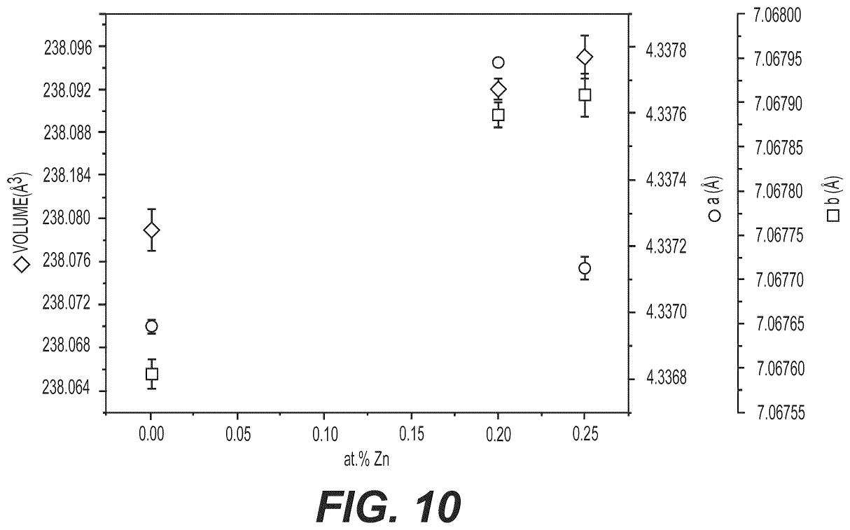

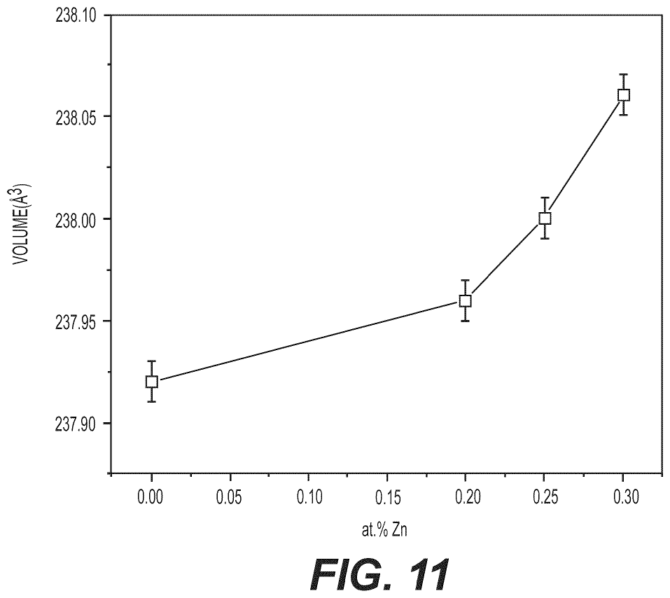

Zn-doping into β-Ag₂Se resulted in the systematic increase of the refined unit cell volume. FIG. 9 shows the dependence of the unit cell volume (obtained from Rietveld refinement) on the % Zn-dopant concentration as determined from WDS. FIG. 10 provides plots of lattice parameters and unit cell volume of pristine, 0.2 at. %, and 0.25 at. % Zn-doped Ag₂Se samples. FIG. 11 shows the dependence of unit cell volume (obtained from Rietveld refinements of room-temperature in-house PXRD) versus % Zn-dopant concentration as determined from WDS. Since the ionic radius for Zn²⁺ (0.74 Å) is smaller than that for Ag⁺ (1.15 Å), the interstitial rather than substitutional nature of doping was hypothesized based on the overall increase of the unit cell volume.

Pair distribution functions (PDF) from total X-ray scattering experiments were analyzed to characterize any amorphous phases which may not have been detected by the diffraction studies. Finely ground powders for synchrotron X-ray total scattering were loaded into a quartz capillary with 0.5 mm ID (0.7 mm outer diameter), evacuated and flame sealed. The quartz capillaries were then transferred into Kapton tubes and sealed with clay on either end. X-ray total scattering data were collected at beamline 11-ID-B at APS ANL with a photon wavelength of λ=0.21160 Å. The CeO₂ standard was used to calibrate the sample-detector distance. To perform background subtraction, data were collected on an empty quartz capillary loaded in an empty Kapton tube. Data were collected at room temperature (25° C.). A reduced scattering structure function, S (Q), with the appropriate corrections for instrument parameters, scattering by silica capillary plus Kapton, multiple scattering, sample absorption, X-ray polarization, and Compton scattering was obtained using the program PDF Suite/PDFgetX3. The pair distribution function (PDF), G(r), was obtained by direct Fourier transformation of S (Q) with a 2 Å⁻¹<Q<20 Å⁻¹. PDFs were fitted and analyzed using the program PDFGUI. The parameter Q_{damp} was fixed to 0.001 and other parameters were allowed to refine.

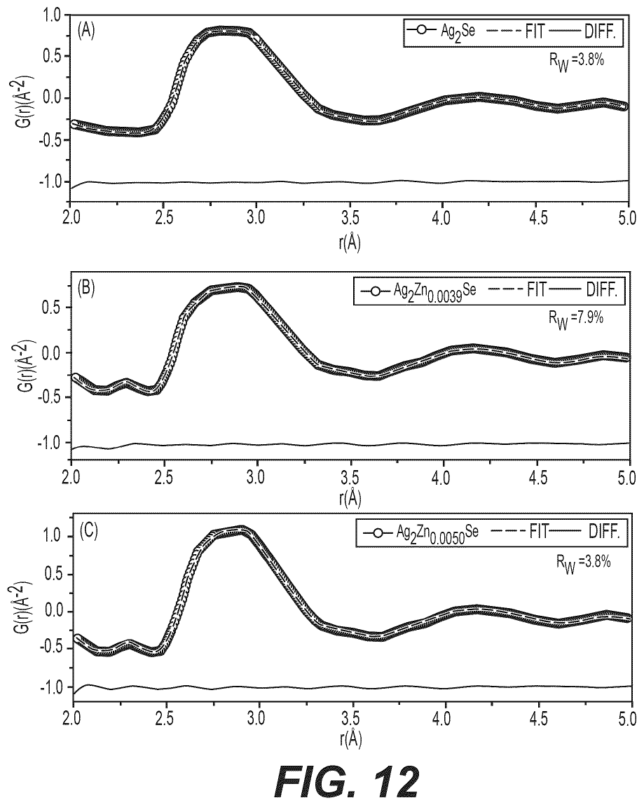

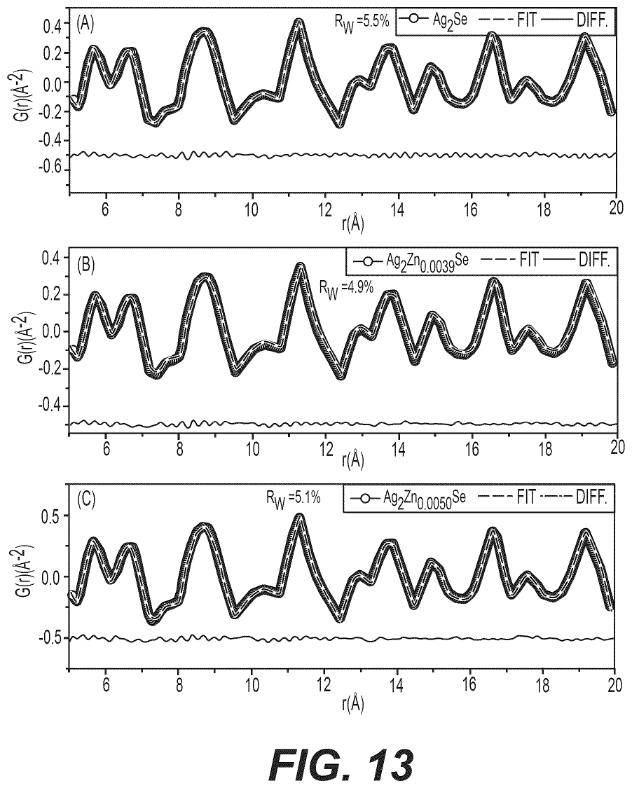

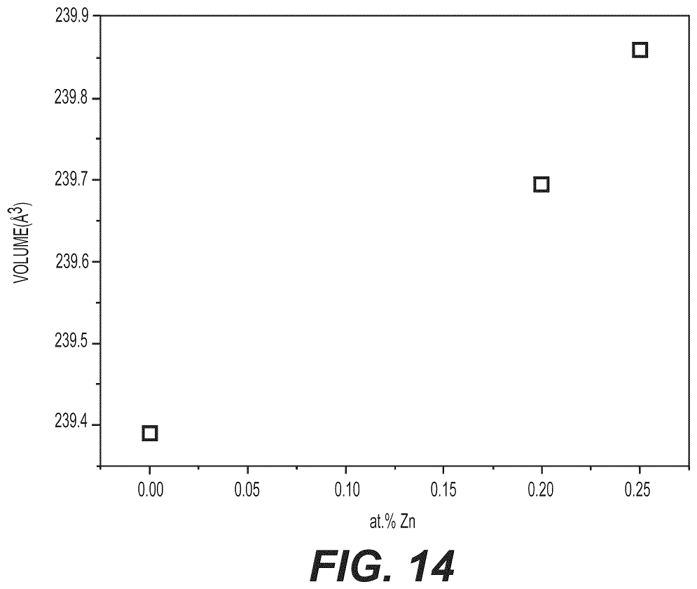

The PDF curves for both short range (2 Å≤r≤5 Å) (FIG. 12) and long range (5 Å ≤r≤20 Å) (FIG. 13) were adequately fit by the orthorhombic β-Ag₂Se structural model without any amorphous impurities within the limit of the experiment, in support of the high phase purity of samples. The similarity in PDFs for both pristine and Zn-doped Ag₂Se samples is expected for such low level of doping. However, an increase in unit cell volume with Zn doping (FIG. 14) was observed—a result consistent with the diffraction studies.

To understand the impact of Zn dopant on the phonon interactions, Raman scattering experiments were performed. Raman spectroscopy measurements were performed using a Horiba XploRA Plus confocal Raman microscope with a 785 nm laser operating at 22 mW and a 50× objective (0.5 NA). The spectra were collected from 50-600 cm⁻¹ with 600 grooves mm⁻¹ grating. Three randomly selected locations were analyzed and averaged for each sample. Raman spectrum was collected with a 30 second acquisition and 3 accumulations. The Raman data were plotted, and peaks were fitted to a Gaussian function using Igor Pro 6.37 (WaveMetrics, Portland, OR).

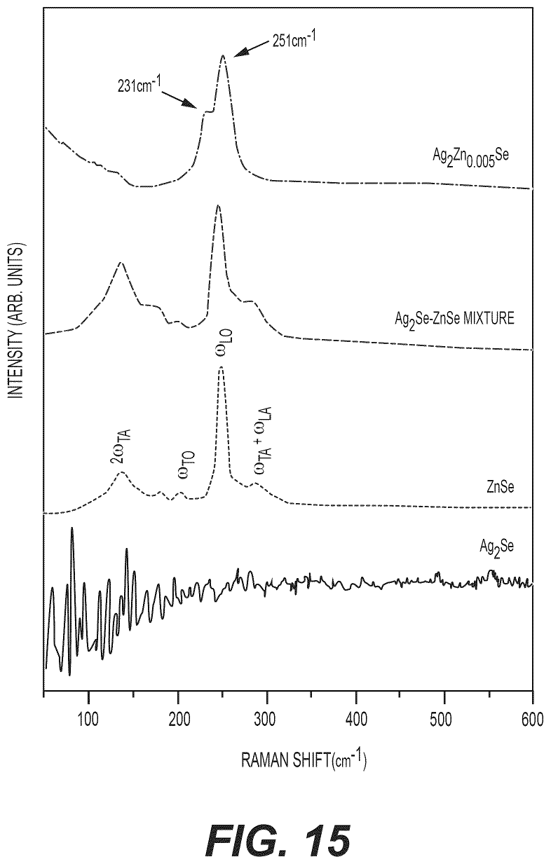

The Raman spectra obtained from the Raman scattering experiments are shown in FIG. 15. Two peaks around 231 cm⁻¹ and 251 cm⁻¹ in the Ag₂Zn_{0.0050}Se Raman spectra have frequencies which are similar to those for the surface and longitudinal optical (ω_{LO}) phonon modes of ZnSe, respectively. Given that there exist two Ag sites in β-Ag₂Se structure with tetrahedral and trigonal coordination, the low frequency mode may be attributed to trigonal Zn interaction with Se atoms. To ensure that the observed modes are not from an admixture ZnSe secondary phase, a control Raman spectrum was obtained on pristine Ag₂Se, ZnSe, and mechanically combined mixture Ag₂Se—ZnSe. Pristine Ag₂Se shows no Raman vibrational modes in the studied region. On the other hand, peaks corresponding to the transverse and longitudinal optical and acoustic modes of ZnSe were observed for both pristine ZnSe and the mechanically mixed Ag₂Se—ZnSe samples. Raman peaks around 200 cm⁻¹ and 250 cm⁻¹ correspond to transverse optical (Ω_{TO}) and longitudinal optical (Ω_{LO}) phonon modes of ZnSe, respectively. Peaks around 138 cm⁻¹ and 270 cm⁻¹ correspond to two-transverse acoustic (COTA) and double-phonon excitation (Ω_{TA}+Ω_{LA}) modes, respectively. Most of the latter modes are absent in the Raman spectrum of the Zn-doped Ag₂Se sample indicating that the observed Raman peaks cannot be ascribed to ZnSe impurities.

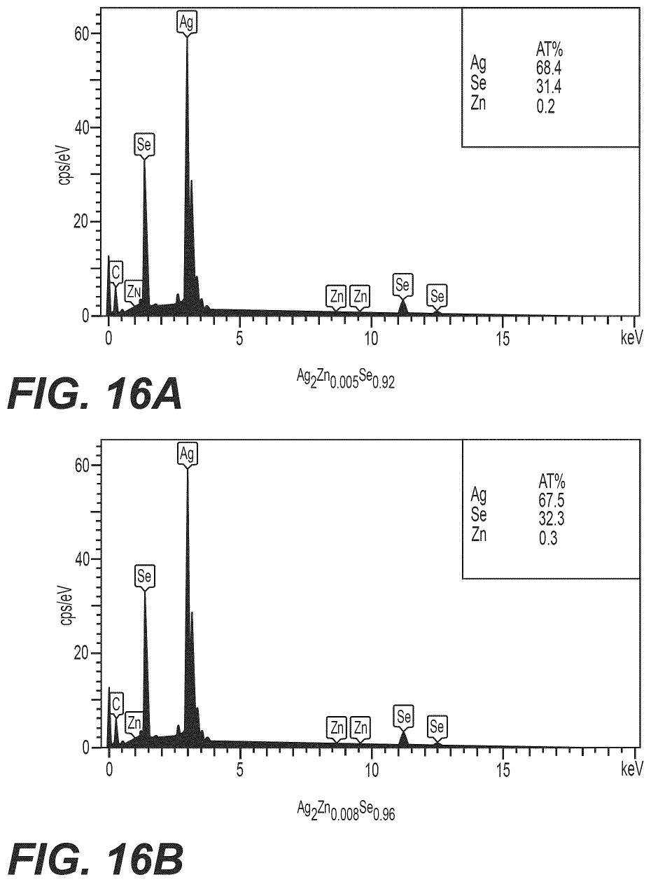

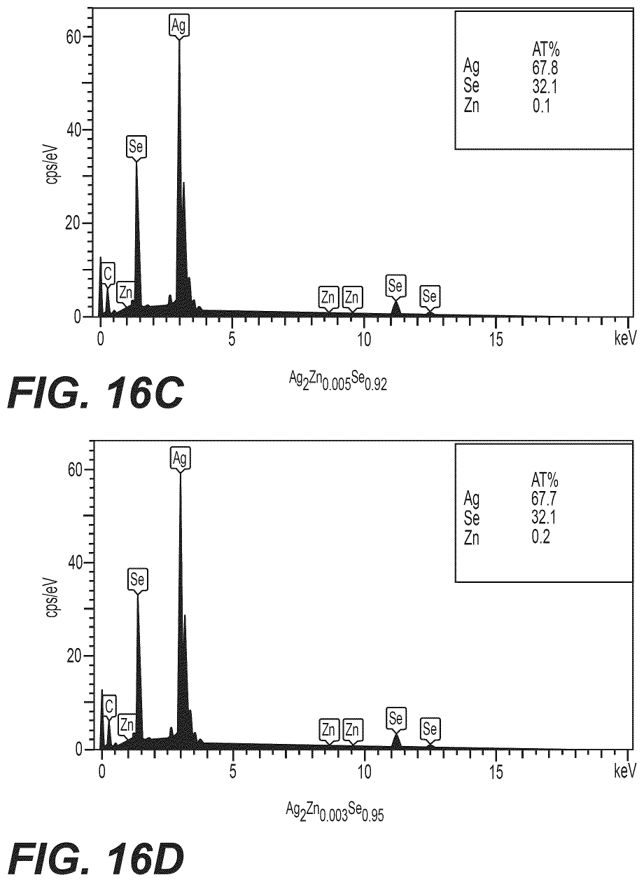

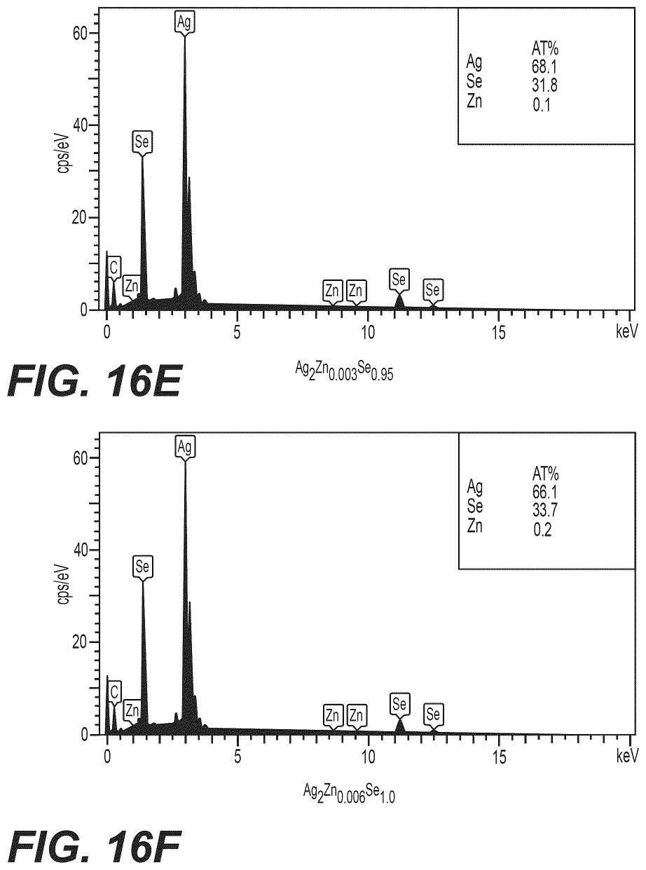

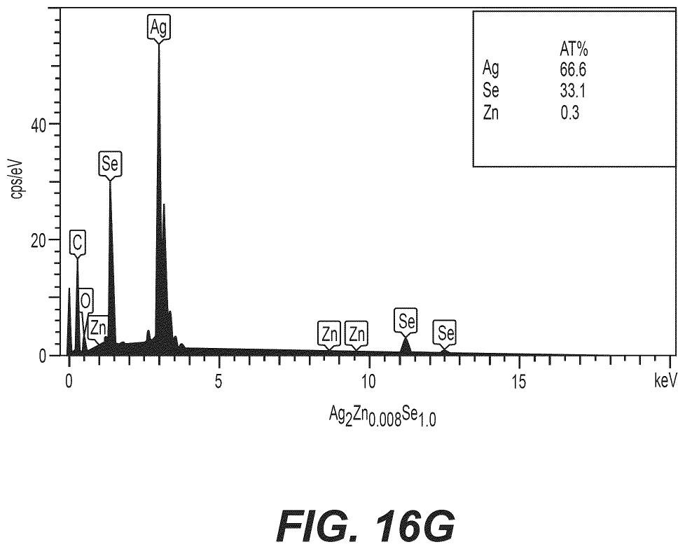

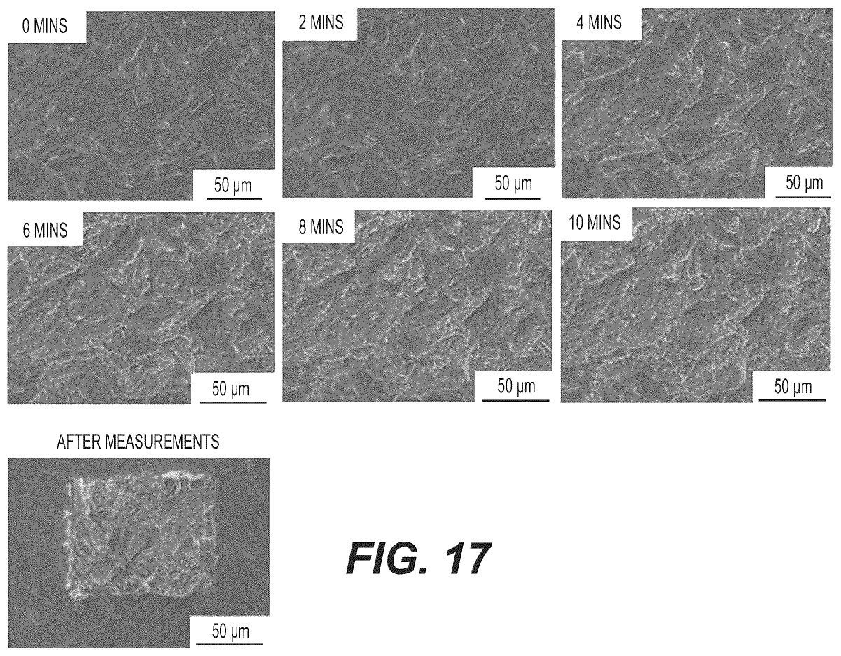

Energy dispersive X-ray spectroscopy (EDS) was employed to determine the atomic ratio of Ag and Se. FIGS. 16A-G provides a table of EDS spectra of selected sites from the 0.25% Zn-doped Ag₂Se sample normalized to 2 Ag atoms. The low level of Zn doping was challenging to quantify reliably using EDS; hence, wavelength dispersive spectroscopy (WDS) was employed for Zn quantification. The slight deficiency in Se obtained from EDS and WDS was attributed to the evaporation of Se due to the high acceleration voltage (20 kV) and small spot size employed during WDS measurements. FIG. 17 provides backscattered SEM images of 0.25% Zn-doped Ag₂Se sample collected during and after a SEM/WDS measurement. Upon prolonged exposure to the beam, samples degraded both visibly and according to elemental analysis (loss of Zn and Se). Table 1, below, provides a summary of atomic composition of Ag, Se and Zn obtained from EDS/WDS for Zn-doped Ag₂Se.

TABLE 1
Atomic Compositions of Zn-doped Ag₂Se Samples

| | At. % of | At. % of | At. % of | | At. % |
|---|---|---|---|---|---|
| % Nominal | Ag | Se | Zn | Composition from | Actual |
| Zn | EDS | EDS | WDS | EDS + WDS | Zn |
| 0.2 | 68.0(8) | 32.1(7) | 0.13(2) | Ag₂Zn_{0.0039(3)}Se_{0.944(3)} | 0.20 |
| 0.3 | 68.4(9) | 31.4(5) | 0.17(2) | Ag₂Zn_{0.0050(5)}Se_{0.92(1)} | 0.25 |
| 0.4 | 67.9(9) | 31.9(4) | 0.19(2) | Ag₂Zn_{0.0057(3)}Se_{0.940(4)} | 0.29 |

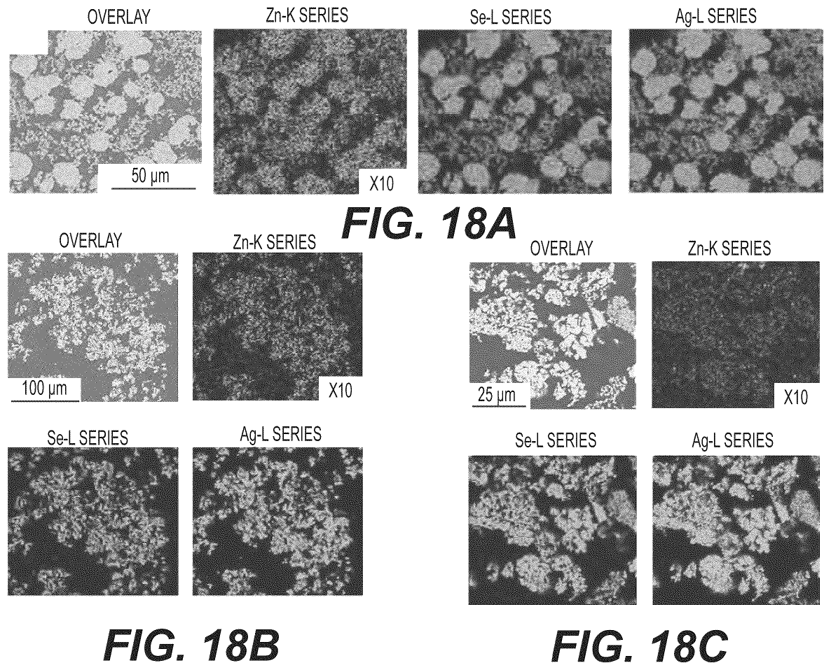

FIGS. 18A-18C show backscattered electron SEM images and the corresponding EDS elemental maps of Zn-doped Ag₂Se samples. In particular, FIGS. 18A-18C depict backscattered SEM images and elemental mapping of 0.2 at. %, 0.25 at. %, and 0.3 at. % Zn-doped Ag₂Se samples, respectively, showing the distribution of Ag, Se, and Zn (the intensity of Zn is increased by 10-fold to enhance visibility). From these figures, it can be seen that the Ag, Se, and Zn were homogeneously distributed, confirming the chemical uniformity of the samples. There was no observable indication of nano-precipitates of ZnSe, consistent with the high-resolution diffraction, total X-ray scattering, and Raman results discussed above and also confirmed by transmission electron microscopy (TEM) analysis discussed below. TEM, including electron diffraction (ED) and high angle annular dark field (HAADF)—scanning TEM (STEM) studies were performed using a JEM ARM200F cold FEG double aberration corrected electron microscope operated at 80 kV/200 kV and equipped with ORIUS Gatan CCD camera, a large solid-angle CENTURIO EDX detector and Quantum EELS spectrometer.

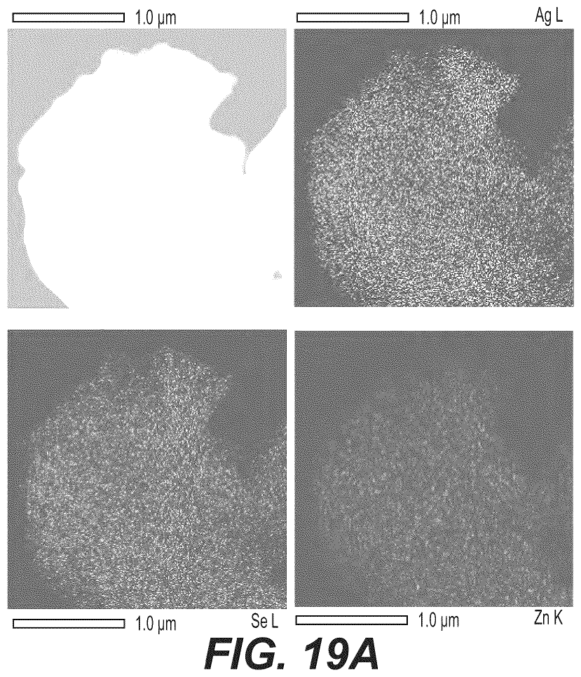

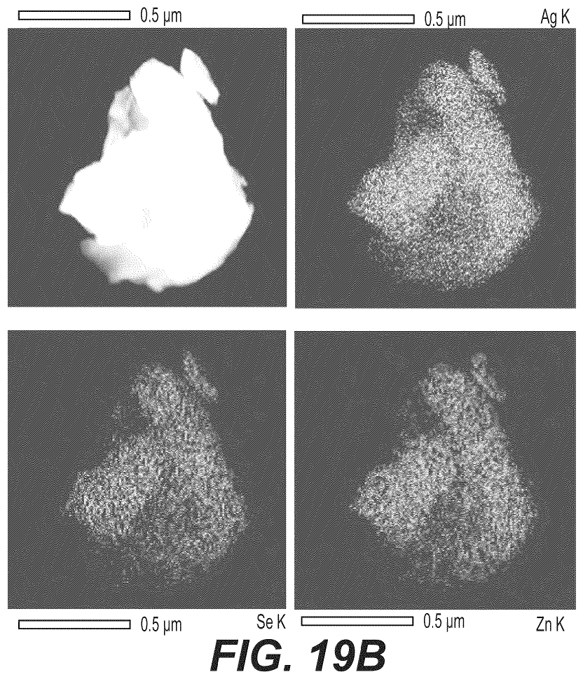

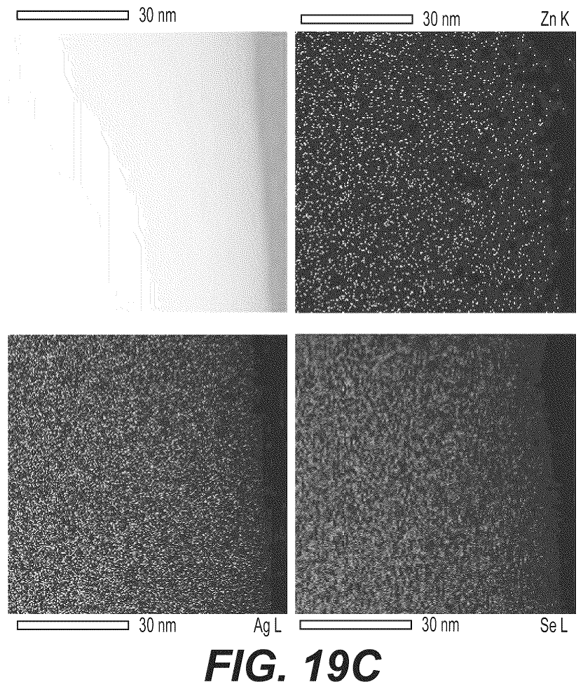

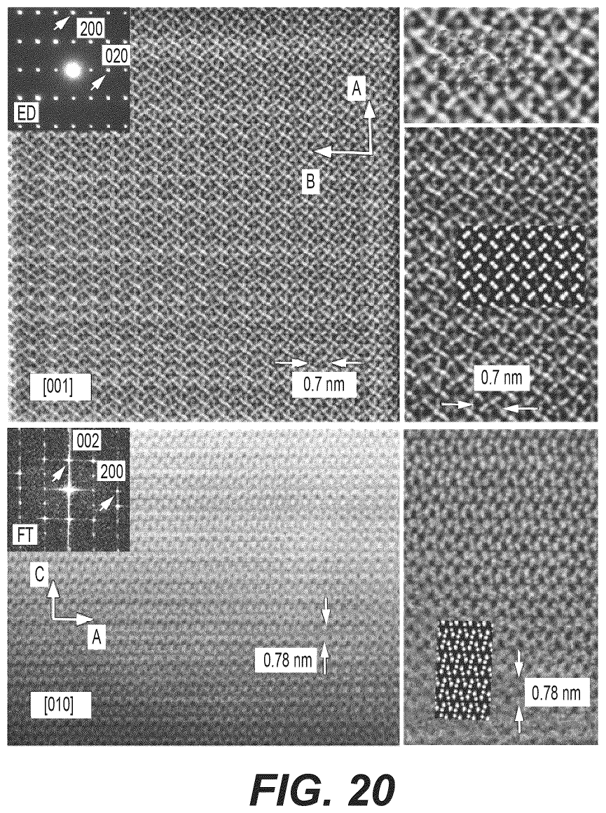

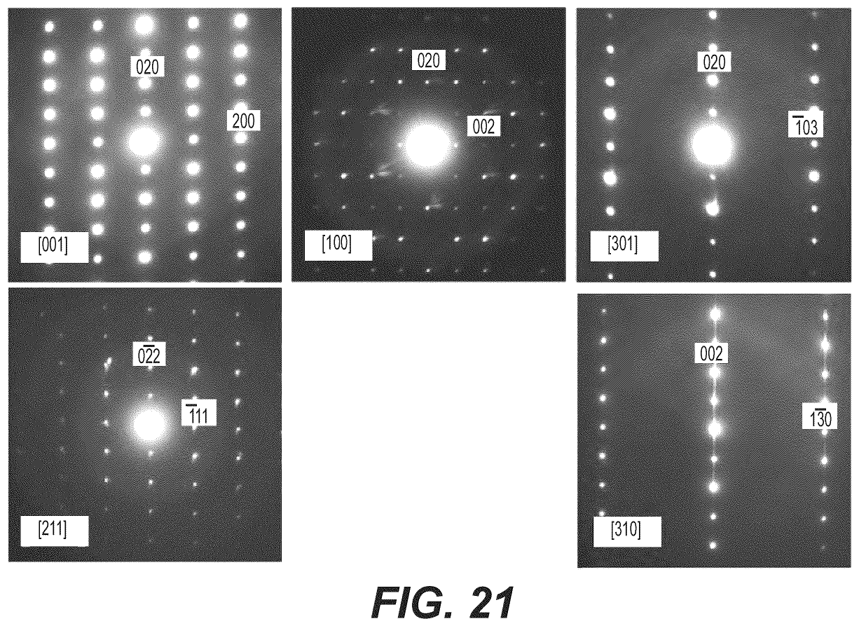

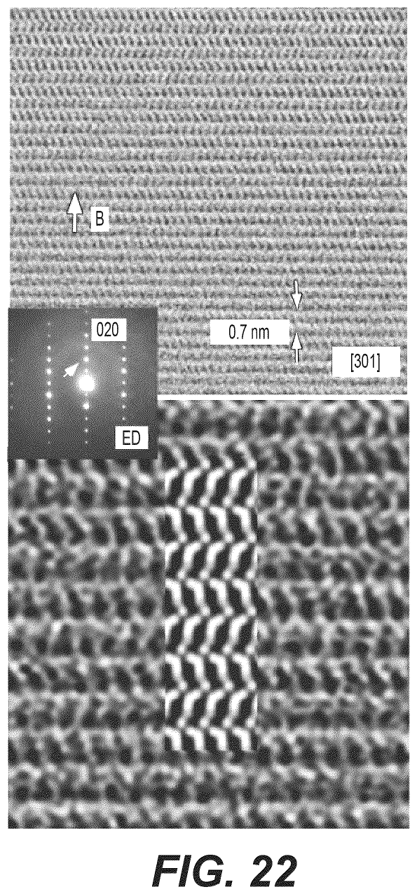

Doped and undopedf μ-Ag₂Se samples appeared to be quite sensitive to the electron beam and obtaining clear scanning-transmission electron microscopy images and diffraction patterns was challenging. Neither secondary Zn-containing phases nor Zn-rich areas were detected. HAADFSTEM EDX mapping showed a homogeneous distribution of Zn atoms across elemental maps of 0.25 at. % Zn-doped Ag₂Se (Ag₂Zn_{0.0050}Se) as shown in FIGS. 19A-C (taken at different levels of magnification). The precise location of Zn atoms was not possible to determine because of beam sensitivity of the samples (even using 80 kV accelerating voltage). Local displacement of the Ag atoms in the case of Zn doping also cannot be excluded, which makes a slight difference between simulated and experimental images as shown in FIG. 20. The observed electron diffraction patterns as shown in FIG. 21 and high resolution HAADF-STEM images shown in FIGS. 20 and 22 of 0.25 at. % Zn-doped Ag₂Se (Ag₂Zn_{0.0050}Se) sample agree well with the structural model of β-Ag₂Se. No substantial structural perturbations were detected supporting the model obtained from Rietveld and PDF refinements of synchrotron diffraction and total scattering data.

The thermoelectric properties of the as-synthesized undoped and Zn-doped β-Ag₂Se samples were measured. Temperature-dependent transport properties were measured on densified 12.7 mm diameter pellets. Electrical conductivity and Seebeck coefficient were measured simultaneously by a standard four-probe method with a Netzsch SBA 458 Nemesis system under an argon atmosphere in the temperature range of 25-130° C. A Netzsch LFA 457 laser flash diffusivity instrument was employed to measure the thermal diffusivity under an argon atmosphere. Pellets were spray-coated with a thin layer of graphite to minimize radiative heat loss from the samples. A standard sample of pyroceram 9606 was used as the reference to measure the specific heat capacity. Total thermal conductivity values were calculated by using the equation K=D×d×Cₚ, where D=thermal diffusivity; d=density obtained from Archimedes method; Cₚ=specific heat capacity. Lattice thermal conductivity (κ_{L}) was calculated by subtracting the electronic thermal conductivity (κₑ) from the total thermal conductivity. κₑ was calculated from the equation κₑ=LTσ (where L=Lorenz number; T=absolute temperature in Kelvin; σ=electrical conductivity). The Lorenz number was calculated from the Seebeck coefficient (S) dependent equation, L=[1.5+^{(|s|/116)}]×10⁻⁸.

Band gap was estimated by fitting the electrical conductivity data to the Arrhenius equation, ln(σ)=A−E_{g}/2k_{B}T, where A=Arrhenius constant; E_{g}=activation energy which may correspond to the bandgap; k_{B}=Boltzmann constant. The power factor (PF) was calculated using PF=S²σ, while the thermoelectric figure-of-merit (zT) was calculated using the equation zT=S²σT/k. The Hall coefficient measurement was carried out using the Electrical Transport option (ETO) on a Quantum Design Physical Property Measurement System (PPMS) on a piece of pellet from 5-400 K by applying an external magnetic field of −3T to 3T and in a five-probe geometry with 50 m platinum wire and silver paste. The carrier concentration was calculated using the equation RH=−n⁻¹e⁻¹ using an average Hall coefficient (RH) value from the full range of magnetic fields, where n is the carrier concentration and e is the charge of an electron. Hall mobility (μ) was calculated using the equation: μ=R_{H}/ρ where ρ is the true resistivity of the sample. Resistivity measurements were conducted with the standard 4-probe configuration with 50 μm platinum leads attached to the pellet via silver paste.

To evaluate reproducibility of measurements, electrical resistivity and Seebeck coefficient were also measured on an LSR-3 LINSEIS system from room temperature to 130° C. under an argon atmosphere. During the measurement, the sample was held between two calomel electrodes and two probe thermocouples with spring-loaded contacts. A resistive heater on the lower electrode created the temperature differentials to determine the Seebeck coefficient.

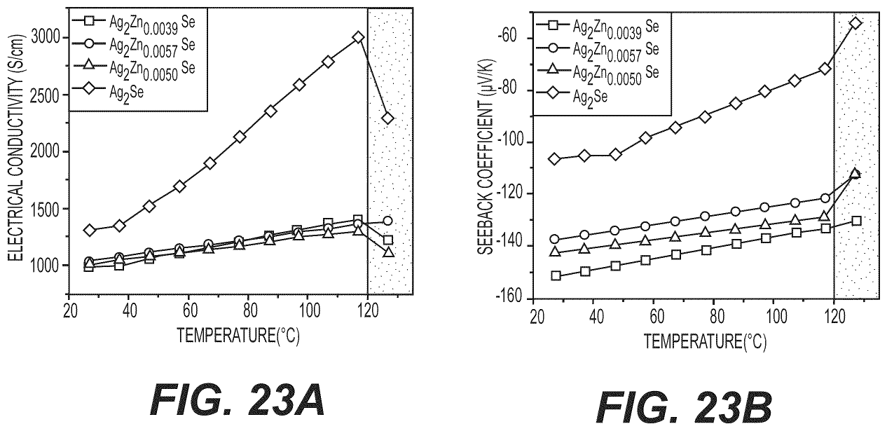

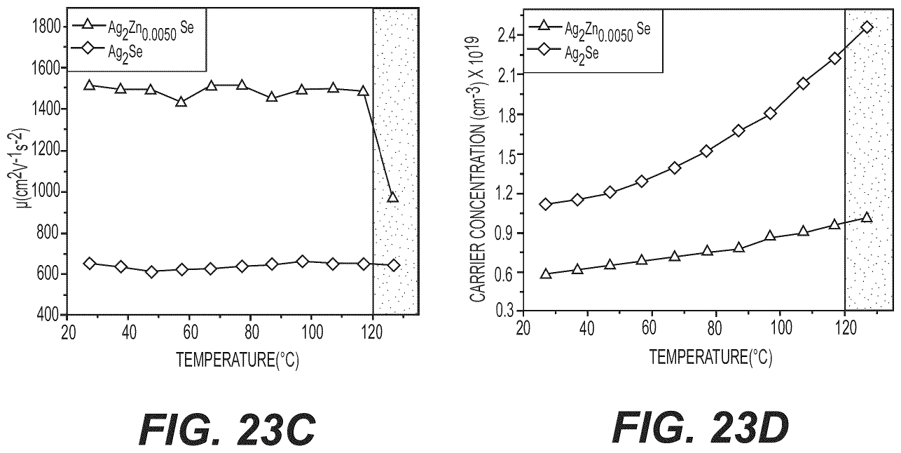

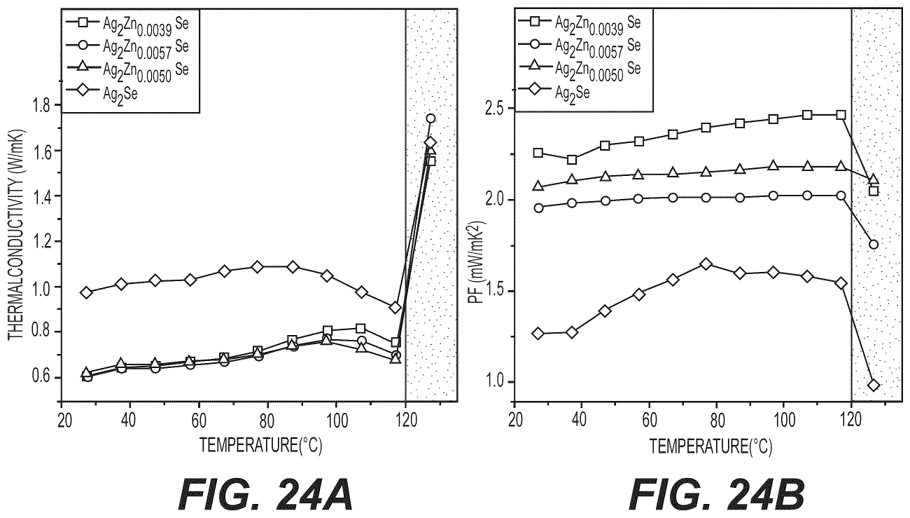

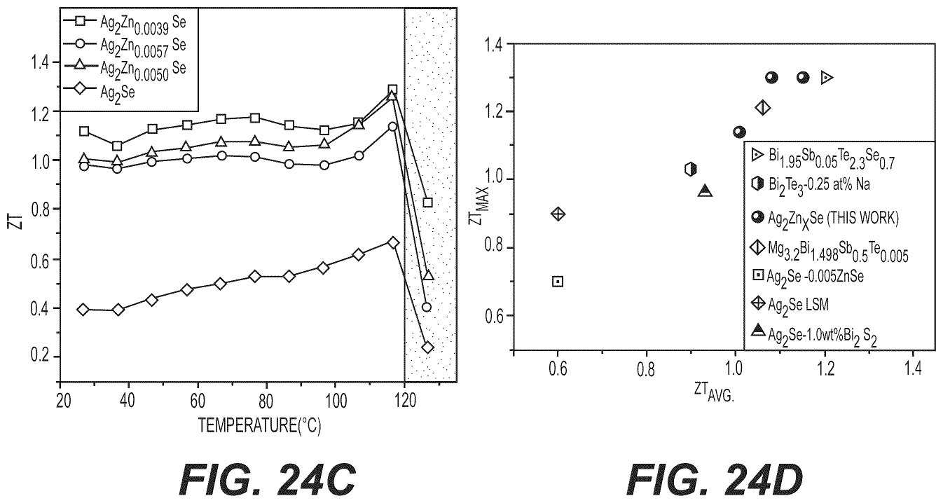

FIGS. 23A and 23B provide graphs of the temperature dependence of the electrical conductivity (FIG. 23A) and Seebeck coefficient (FIG. 23B) for β-Ag₂Se and Ag₂ZnxSe samples (x=0.0039, 0.0050, and 0.0057 corresponding to 0.2, 0.25 and 0.3 at. % Zn doping respectively). FIG. 23C and FIG. 23D provide graphs of the temperature dependence of Hall mobility (FIG. 23C) and carrier concentration (FIG. 23D) of β-Ag₂Se and Ag₂Zn_{0.0050}Se. The two-phase (β→α) region is shaded in gray. FIGS. 24A-C depict the temperature dependence of total thermal conductivity (FIG. 24A), power factor (FIG. 24B), and figure of merit zT (FIG. 24C) for pristine β-Ag₂Se and doped Ag₂ZnₓSe samples (x=0.0039, 0.0050, and 0.0057 corresponding to 0.2, 0.25 and 0.3 at. % Zn doping respectively). The two-phase (β→α) region is again shaded in gray. The sharp change of all properties at −130° C. is associated with the intrusion of superionic high-temperature cubic α-Ag₂Se phase fragments in the orthorhombic lattice of β-Ag₂Se.

FIG. 24D provides a comparison of the peak and average figure of merit zT of Zn-doped β-Ag₂Se samples (25-120° C.) against other state-of-the-art room-temperature thermoelectric materials. This claim is validated by the temperature-dependent in situ diffraction studies, where the appearance of both phases (α and β) was observed around ˜130° C. (as shown in FIG. 4C). This type of mixed lattice structure has been reported to exhibit liquid-like behavior, which promotes high carrier concentration due to the mobility of Ag ions. The coexistence of α and β phases introduces disorder in the lattice structure, which annihilates the mobility of carriers and cause a decrease in electrical conductivity, σ.

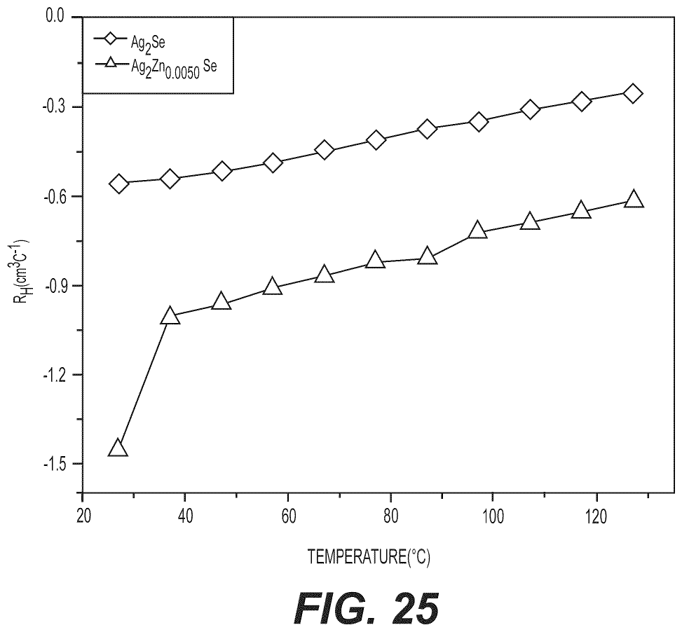

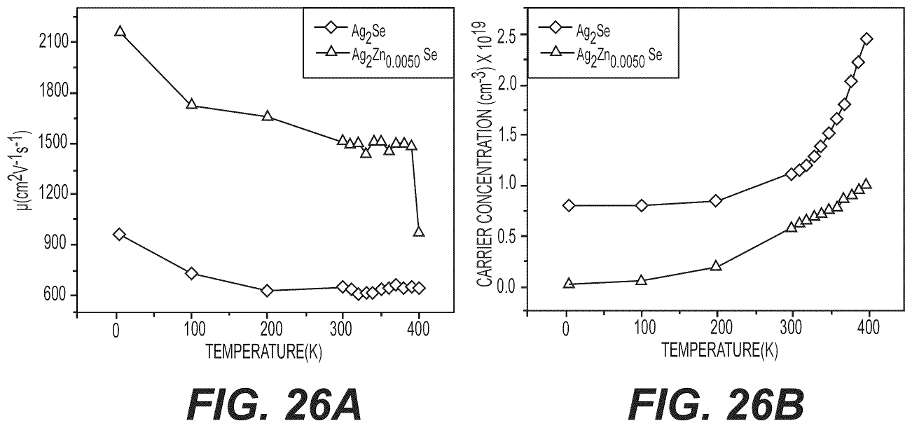

Electrical conductivity of the Zn-doped samples was substantially lower than that for the undoped sample as shown in FIG. 23A. This indicates that Zn-doping is not a simple substitution of Ag⁺ with Zn²⁺ (which is expected to increase the charge carrier concentration and electrical conductivity) but a more complex process. All samples of FIG. 23A show an increase in electrical conductivity with temperature (25-120° C.) due to the intrinsic excitation of carriers. To get a more comprehensive understanding of this phenomenon, Hall effect measurements were carried out on pristine and 0.25 at. % Zn-doped samples as shown in FIG. 23C. The negative values obtained for Hall coefficient are indicative of n-type carrier transport and supported by the observed sign of Seebeck coefficient as shown in FIG. 24B and also as shown in FIG. 25, which shows the temperature dependent Hall concentration of pristine Ag₂Se and 0.25 at. % Zn-doped Ag₂Se samples. Compared with the pristine undoped sample, the Zn-doped Ag₂Se sample exhibits superior Hall mobility and lower carrier concentration as shown in FIGS. 23C and 23D and as also shown in FIGS. 26A-B, which also show the temperature dependent Hall mobility (FIG. 26A) and carrier concentration (FIG. 26B) of pristine Ag₂Se and 0.25 at. % Zn-doped Ag₂Se samples.

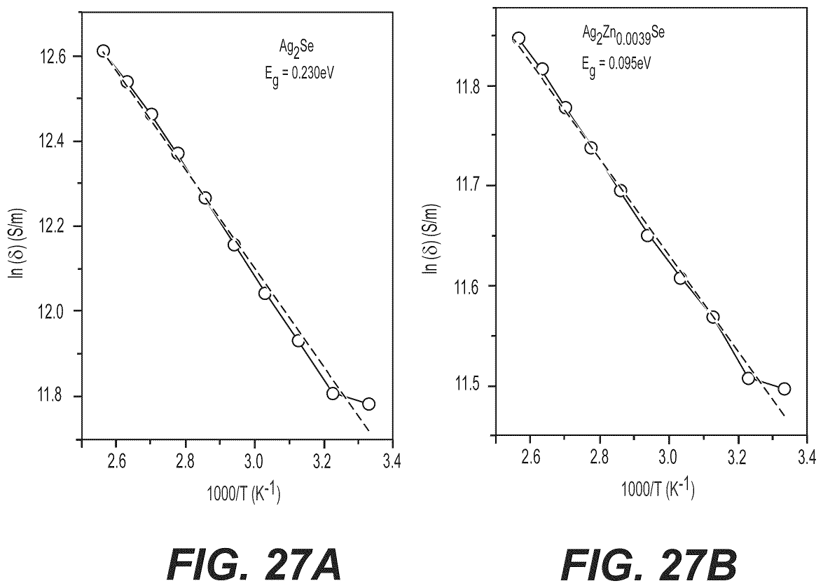

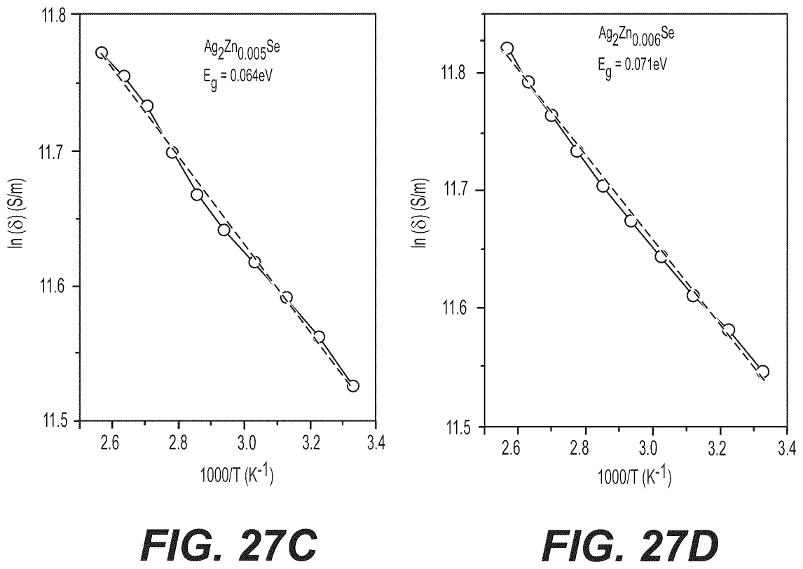

The reduced mobility in undoped samples may be attributed to increased carrier scattering centers introduced by Ag interstitials and vacancies. Thus, the reduction of Ag interstitials/vacancies by Zn doping diminishes carrier scattering, which results in higher carrier mobility. The significant reduction in carrier concentration in Zn-doped Ag₂Se compared with undoped sample is consistent with the observed electrical conductivity values shown in FIG. 23A. An estimation of the bandgap from Arrhenius plot of electrical resistivity (from 300-390 K) yielded values ranging from 0.064 to 0.095 eV as shown in FIGS. 27A-D for Zn-doped samples (FIGS. 27B-D), which is smaller than the bandgap of 0.23 eV for undopedf β-Ag₂Se (FIG. 27A). The latter value of bandgap is consistent with reported values for undoped β-Ag₂Se-based materials.

The electrical conductivity of Zn-doped samples increases slightly (<5%) with increasing Zn content. For example, at room temperature, the electrical conductivity of Ag₂Zn_{0.0039}Se is 983 S/cm, while that of Ag₂Zn_{0.0057}Se sample is 1033 S/cm. Applicant hypothesizes that, at low doping levels, Zn atoms first fill Ag vacancies (Agᵥ) in β-Ag₂Se before beginning to fill interstitial sites. The reduction in Ag vacancies diminishes the carrier scattering, resulting in a decrease in carrier concentration leading to lower σ as shown in FIG. 23A. With further increase in Zn content, the excess Zn atoms enter Ag interstitial sites (Ag₁) causing growth in carrier concentration and a drop in carrier mobility, similar to the recent observation for Cu doped SnSe. The electrical conductivities of all Zn-doped samples show weak temperature dependence compared to the pristine β-Ag₂Se, which can be attributed to the modified band gap. The large bandgap observed for undoped Ag₂Se stems from an offset between the conduction and valence band which increases carrier scattering centers, leading to poor carrier mobility.

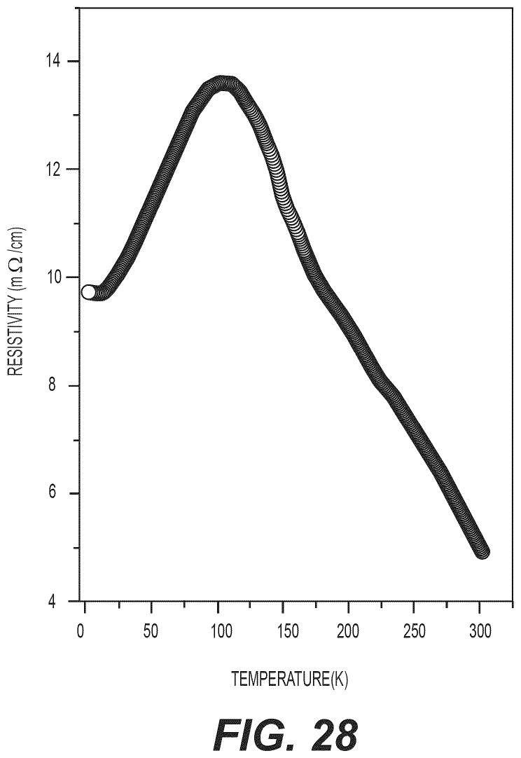

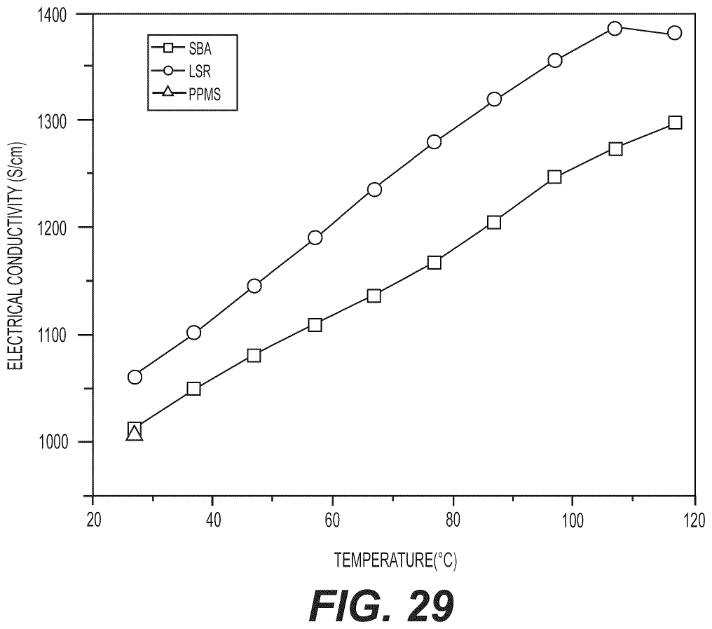

FIG. 28 provides a graph of the temperature-dependent electrical resistivity of Ag₂Zn_{0.0050}Se indicating metallic behavior below 100 K and semiconducting behavior above 100 K. From the low-temperature measurements of electrical resistivity for Ag₂Zn_{0.0050}Se, the concentration of charge carriers below 100 K remains constant, and electron scattering resulted in increased resistivity, indicating metallic behavior. As temperature increases, the electrical conductivity becomes activated, and a typical semiconducting behavior is observed. To check the reproducibility of the observed properties, electrical conductivity was measured using three different instruments: a Quantum Design Physical Property Measurement System (PPMS), Netzsch SBA 458 Nemesis, and LINSEIS LSR-3. All measurements provided reproducible results with conductivity values of 1000-1075 S/cm at room temperature as shown in FIG. 29. For the discussion of thermoelectric properties herein, the data generated using the Netzsch SBA 458 Nemesis was utilized because it provided the lowest values of power factor, resulting in the most conservative zT values.

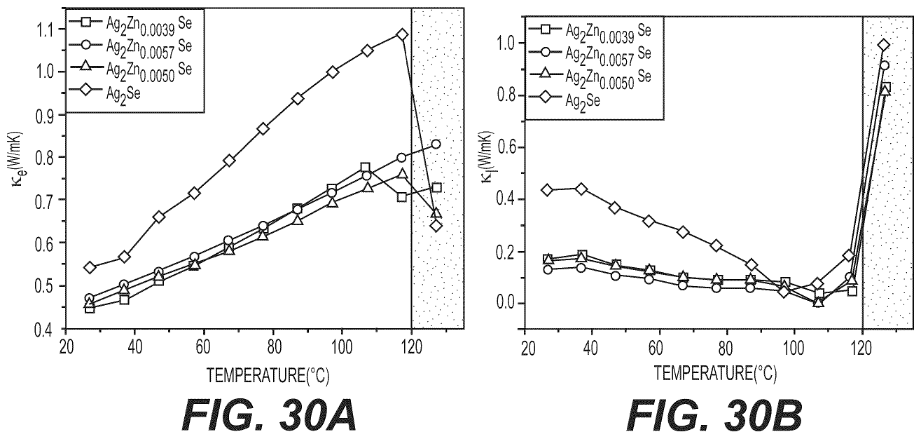

FIG. 23B depicts trends for the temperature dependence of Seebeck coefficient (S) for n-type β-Ag₂Se. A decrease in absolute values of S with increasing temperature is observed for all samples and consistent with previous reports for n-type semiconductors. The inverse relationship between S and n results in a decrease in the thermopower with an increase in carrier concentration, a phenomenon indicative of single-band transport. The remarkable improvement in S for Zn-doped Ag₂Se compared with the undoped sample benefited from a decrease in carrier concentration. The temperature dependencies of thermal conductivity for all samples are presented in FIG. 24A. All Zn-doped samples have low thermal conductivity (below 0.8 W/mK prior to the phase transition) over the measured temperature range (25-130° C.). FIGS. 30A and 30B provide the temperature dependence of electronic (FIG. 30A) and lattice thermal conductivities (FIG. 30B) for pristine β-Ag₂Se and Ag₂ZnₓSe samples (x=0.0039, 0.0050, and 0.0057) in which the two phase region α- and β-Ag₂Se The electronic thermal conductivity (κₑ=LσT, where L is the Lorenz number) was estimated from the Seebeck coefficient data provided in FIG. 30A. From Ke, the lattice thermal conductivity, κ_{L}, was computed (κₜₒₜ−κₑ) and is shown in FIG. 30B. The values of K_{L} for the disclosed Zn-doped samples across the measured temperature range are ultralow and close to the glassy limit for crystalline materials, a typical characteristic of disordered crystals. The relatively low K could be attributed to two phenomena. First, the reduced electrical conductivity originating from the reduced carrier concentration suppresses κₑ as shown in FIG. 30A. Second, introducing Zn into Ag vacancies/interstitials may give rise to point defects or ionic migration, leading to increased phonon scattering and decreased lattice thermal conductivity. The sudden rise in thermal conductivity at 130° C. to ˜1.6 W/mK for all samples (FIG. 24A) results from an increase in specific heat capacity at the phase transition.

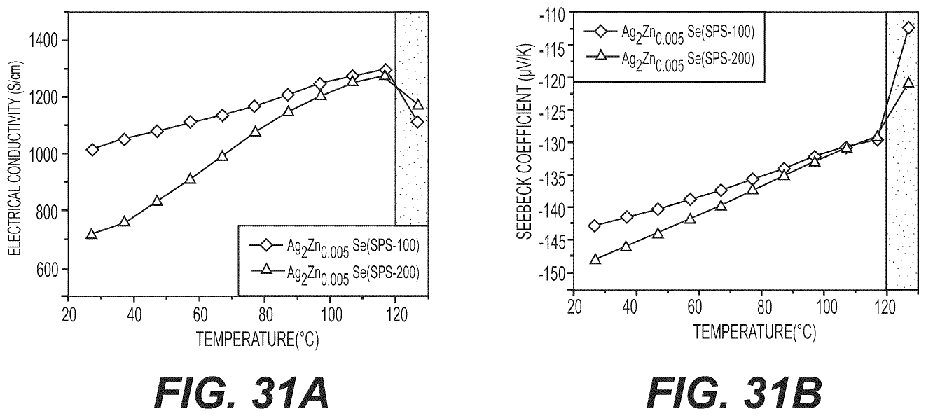

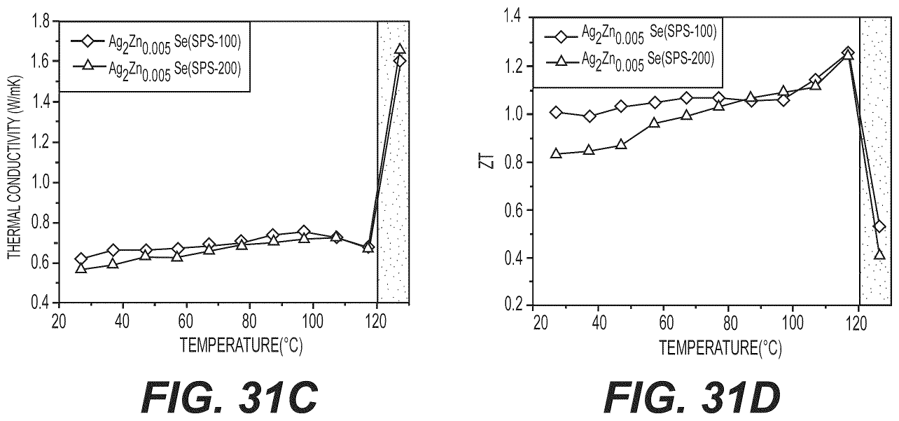

To determine whether sintering temperature impacts the electrical and thermal transport properties of Zn-doped β-Ag₂Se samples, an additional batch of 0.25 at. % Zn-doped Ag₂Se was synthesized and consolidated it into pellets at 100° C. (SPS-100) and 200° C. (SPS-200). In the range of 25-90° C., significantly lower electrical conductivity was observed in SPS-200 compared with SPS-100 as shown in FIG. 31A. With sample exposure to temperatures above the β→α phase transition during sintering, tiny inclusions of α-Ag₂Se phase in the β-Ag₂Se matrix may form and impede the concentration of carriers resulting in lower electrical conductivity. As we approach the phase transition (90-127° C.), the electrical conductivity is more similar between SPS-100 and SPS-200, although SPS-200 still lags until ˜115° C. The drop in carrier concentration slightly impacts the Seebeck coefficient (FIG. 31B) and thermal conductivity (FIG. 31C) between 25-90° C., and levels up with SPS-100 at high temperatures. Thus, exposing Ag₂Se samples to temperatures above the β→α phase transition during synthesis and/or post-synthetic treatment may be detrimental to the transport properties. This reinforces the need to carry out synthesis and material processing at temperatures below 130° C., favoring solution-based synthetic approaches.

The temperature-dependent power factors (PF) (FIG. 24B) for all Zn-doped samples gradually increased from room temperature to 100° C. and remained constant till 120° C.; after this temperature, PF decreases due to the onset of the β→α phase transition. The maximum PF for Zn-doped samples is about 2-fold higher than in the undoped sample. Owing to the well-maintained high electrical transport properties (PF) and the largely suppressed thermal conductivity resulting from Zn doping, the zT values of β-Ag₂Se can be enhanced via Zn doping from 0.7 to 1.3 at 120° C. (FIG. 24C). Besides boosting the peak value, the average zT values across the whole temperature range (25-120° C.) were also tremendously improved to 0.98-1.15 for different Zn concentrations. For traditional Bi₂Te₃-based thermoelectric materials, low performance of the n-type materials limits the energy conversion efficiency of room-temperature thermoelectric modules. Applicant envisions that the simplicity of synthesis and enhanced average zT values in n-type Zn-doped Ag₂Se materials should push forward the applications for such thermoelectric devices.

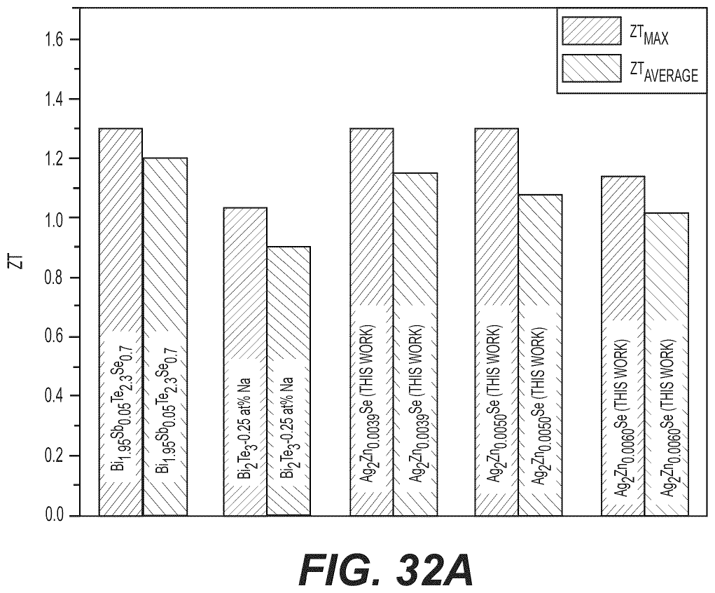

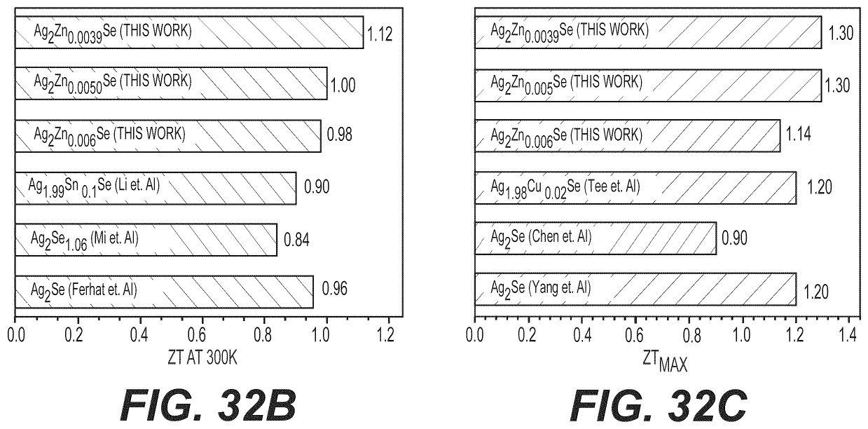

Thus, accordingly to the present disclosure, uniformly Zn-doped Ag₂Se samples can be facilely synthesized by utilizing benchtop chemistry starting from benign reagents, elemental Se, AgCl, and ZnCl₂. Synthesis and sintering of pellets at 100° C. avoid the formation of high-temperature phases because samples are never exposed to temperatures above the βΘα phase transition. The results demonstrated herein show that Zn can be successfully doped on the level of up to 0.3 at. % into the β-Ag₂Se matrix which drastically modifies transport properties of the material. Owing to the controlled level of doping and low synthetic/processing temperatures, Zn-doped samples produced according to the present disclosure demonstrated remarkable thermoelectric performance with a maximum zT of 1.3 and averaged zT of 1.15 in 25-120° C. range which outperforms all reported β-Ag₂Se materials as shown in FIGS. 32A-C and is on par with the best n-type Bi₂Te₃-based and Mg₃Bi₂-based materials as shown in FIG. 24D. The latter materials require high-temperatures and complex synthetic modifications, while the presently disclosed synthesis employs a simple and sustainable benchtop chemistry to yield efficient room temperature thermoelectric materials.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of preparing a thermoelectric compound, comprising:
heating a solution comprising Se to a temperature below 130° C.;
adding a first compound comprising Ag to the solution to form a mixture; and
reacting the mixture to produce a β-Ag₂Se compound.

2. The method of claim 1, wherein the solution comprises a monoamine, a polyamine, or an alkanol amine.

3. The method of claim 1, wherein the solution comprises ethylenediamine, diaminopropane, diethylenetriamine, alkylamine, ethanolamine, or propanolamine.

4. The method of claim 1, wherein the first compound is a salt of Ag.

5. The method of claim 4, wherein the salt of Ag is a halide, AgNO₃ and Ag₂CO₃.

6. The method of claim 1, wherein the adding further comprises adding a second compound comprising an element other than Ag.

7. The method of claim 6, wherein the element is Zn, Mg, Al, P, Si, Mn, Ni, Pb, Cd, Sn, Bi, S, or Te.

8. The method of claim 6, wherein the β-Ag₂Se compound comprises up to 1.0 at % of the element.

9. The method of claim 1, wherein the β-Ag₂Se compound comprises a figure of merit zT of at least 0.7 at 120° C.

10. The method of claim 1, wherein the β-Ag₂Se compound comprises an average figure of merit zT of at least 0.98 across a whole temperature range of 25° C. to 120° C.

11. A method of preparing a thermoelectric compound, comprising:
adding one or more solid reactants comprising Se and Ag to a solvent to form a mixture, the solvent being heated to a temperature below 130° C.; and
reacting the mixture to produce a β-Ag₂Se compound.

12. The method of claim 11, wherein the solvent comprises a monoamine, a polyamine, or an alkanol amine.

13. The method of claim 11, wherein the solvent comprises ethylenediamine, diaminopropane, diethylenetriamine, alkyl amine, ethanolamine, or propanol amine.

14. The method of claim 11, wherein a first solid reactant of the one or more solid reactants is a salt of Ag.

15. The method of claim 14, wherein the salt of Ag is a halide, AgNO₃ and Ag₂CO₃.

16. The method of claim 14, wherein a second solid reactant of the one or more solid reactants is elemental selenium.

17. The method of claim 16, wherein the one or more solid reactants further comprises a third solid reactant comprising an element other than Ag.

18. The method of claim 17, wherein the element is Zn, Mg, Al, P, Si, Mn, Ni, Pb, Cd, Sn, Bi, S, or Te.

19. The method of claim 17, wherein the β-Ag₂Se compound comprises up to 1.0 at % of the element.

20. The method of claim 11, wherein the β-Ag₂Se compound comprises a figure of merit zT of at least 0.7 at 120° C.

21. The method of claim 11, wherein the β-Ag₂Se compound comprises an average figure of merit zT of at least 0.98 across a whole temperature range of 25° C. to 120° C.

22. A thermoelectric compound, comprising:
β-Ag₂Se; and
a dopant;
wherein the thermoelectric compound comprises a figure of merit zT of at least 0.7 at 120° C.

23. The thermoelectric compound of claim 22, wherein the dopant is Zn, Mg, Al, P, Si, Mn, Ni, Pb, Cd, Sn, Bi, S, or Te.

24. The thermoelectric compound of claim 22, wherein the thermoelectric comopund comprises up to 1.0 at % of the dopant.

25. The thermoelectric compound of claim 22, wherein the thermoelectric compound comprises an average figure of merit zT of at least 0.98 across a whole temperature range of 25° C. to 120° C.
